(19) United States
(12) Patent Application Publication
(10) Pub. No.: US 2025/0116846 A1
(43) Pub. Date: Apr. 10, 2025

(54) OPTICAL IMAGING LENS ASSEMBLY

(71) Applicant: Zhejiang Sunny Optics Co., Ltd., Yuyao City (CN)

(72) Inventors: Yazhu SONG, Yuyao City (CN); Yang LI, Yuyao City (CN); Jiadong ZHU, Yuyao City (CN); Rongbo FANG, Yuyao City (CN); Jianke WENREN, Yuyao City (CN); Fujian DAI, Yuyao City (CN)

(21) Appl. No.: 18/981,760

(22) Filed: Dec. 16, 2024

(30) Foreign Application Priority Data
Jun. 17, 2024 (CN) 202410779043.8

(51) Int. Cl. G02B 13/00; G02B 7/02; G02B 9/64; G02B 27/00

(52) U.S. Cl. CPC G02B 13/0045; G02B 7/021; G02B 9/64; G02B 27/0018

(57) ABSTRACT

An optical imaging lens assembly includes a lens barrel, first to seventh lenses sequentially arranged along an optical axis from an object side to an image side, a fifth spacing piece and a sixth spacing piece. The fifth spacing piece is placed between the fifth lens and the sixth lens, and the sixth spacing piece is placed between the sixth lens and the seventh lens. A maximal thickness CP6 of the sixth spacing piece along a direction of the optical axis is greater than a center thickness CT6 of the sixth lens on the optical axis. An inner diameter d5s of an object-side surface of the fifth spacing piece, an inner diameter d6s of an object-side surface of the sixth spacing piece, and a spacing distance T56 between the fifth lens and the sixth lens on the optical axis satisfy: 4.5<(d6s−d5s)/T56<8.0.

### CROSS-REFERENCE TO RELATED APPLICATIONS

This application claims the priority from Chinese Patent Application No. 202410779043.8, filed in the National Intellectual Property Administration (CNIPA) on Jun. 17, 2024, the contents of which are hereby incorporated by reference in their entirety.

### TECHNICAL FIELD

The present disclosure relates to the field of optical devices, and specifically to an optical imaging lens assembly.

### BACKGROUND

With the rapid development of diversified camera functions of portable devices such as smartphones, the requirements for optical lens assemblies configured in the portable devices such as the smartphones are getting higher and higher to meet different camera needs, and accordingly, the number of the lenses in the optical imaging lens assemblies is increasing. For example, some mobile phone models are equipped with optical imaging lens assemblies such as a main camera, a telephoto lens assembly, a wide-angle lens assembly and a macro lens assembly for photographing in various scenarios. With the increase of the number of the lenses in the optical imaging lens assemblies, the imaging specifications of the optical imaging assemblies are gradually tightened, and particularly, the photographing quality of an optical imaging lens assembly as the main camera needs to satisfy various photography scenarios, and the assessment on stray light ghost images is more stringent.

The larger the number of the lenses in the optical imaging lens assembly as the main camera with a large image plane is, the greater the probability of stray light ghost images is, and thus, the design difficulty increases greatly. Meanwhile, for the position at which there is a large segment difference or large spacing inside the lens group, the risk of stray light reflected by the inner-diameter surface of a spacing piece increases, affecting the overall photographing quality of the optical imaging lens assembly.

### SUMMARY

Implementations of the present disclosure provide an optical imaging lens assembly that at least or partially solve at least one problem or other problem in existing technologies.

Implementations of the present disclosure provide an optical imaging lens assembly. The optical imaging lens assembly includes an optical lens group, a spacing piece group, and a lens barrel. The optical lens group includes a first lens, a second lens, a third lens, a fourth lens, a fifth lens, a sixth lens and a seventh lens that are sequentially arranged along an optical axis from an object side to an image side, where the first lens has a positive refractive power, the second lens has a negative refractive power, the third lens has a negative refractive power, the fourth lens has a positive refractive power, the fifth lens has a positive refractive power, the sixth lens has a positive refractive power, and the seventh lens has a negative refractive power. The spacing piece group includes a fifth spacing piece and a sixth spacing piece, where the fifth spacing piece is placed between the fifth lens and the sixth lens and in at least partial contact with the fifth lens, and the sixth spacing piece is placed between the sixth lens and the seventh lens and in at least partial contact with the sixth lens. The lens barrel accommodates the optical lens group and the spacing piece group. A maximal thickness CP6 of the sixth spacing piece along a direction of the optical axis is greater than a center thickness CT6 of the sixth lens on the optical axis. An inner diameter d5s of an object-side surface of the fifth spacing piece, an inner diameter d6s of an object-side surface of the sixth spacing piece, and a spacing distance T56 between the fifth lens and the sixth lens on the optical axis satisfy: 4.5<(d6s−d5s)/T56<8.0.

According to an implementation of the present disclosure, there is an spacing distance between adjacent lenses.

According to an implementation of the present disclosure, the spacing piece group further comprises a fourth spacing piece, and the fourth spacing piece is placed between the fourth lens and the fifth lens and in at least partial contact with the fourth lens, where an inner diameter d4s of an object-side surface of the fourth spacing piece and a maximal effective radius DT42 of an image-side surface of the fourth lens satisfy:

$$2. < d 4 s / DT 42 < 2.8 .$$

According to an implementation of the present disclosure, the spacing piece group further comprises a fourth spacing piece, and the fourth spacing piece is placed between the fourth lens and the fifth lens and in at least partial contact with the fourth lens, where a spacing distance EP45 between an image-side surface of the fourth spacing piece and the object-side surface of the fifth spacing piece along the direction of the optical axis, an outer diameter D5s of the object-side surface of the fifth spacing piece, and an outer diameter D4m of the image-side surface of the fourth spacing piece satisfy: 0.1<EP45/(D5s−D4m)<0.6.

According to an implementation of the present disclosure, the spacing piece group further comprises a second spacing piece and a third spacing piece, the second spacing piece is placed between the second lens and the third lens and in at least partial contact with the second lens, and the third spacing piece is placed between the third lens and the fourth lens and in at least partial contact with the third lens, where a spacing distance EP23 between an image-side surface of the second spacing piece and an object-side surface of the third spacing piece along the direction of the optical axis and a center thickness CT3 of the third lens on the optical axis satisfy: 1.0<EP23/CT3<2.0.

According to an implementation of the present disclosure, the spacing piece group further comprises a first spacing piece, and the first spacing piece is placed between the first lens and the second lens and in at least partial contact with the first lens, where a radius of curvature R1 of an object-side surface of the first lens, a radius of curvature R2 of an image-side surface of the first lens, and an inner diameter d1s of an object-side surface of the first spacing piece satisfy: 3.0<(R1+R2)/d1s<4.5.

According to an implementation of the present disclosure, the spacing piece group further comprises a first spacing piece, and the first spacing piece is placed between the first lens and the second lens and in at least partial contact with the first lens, where a spacing distance EP01 from an object-side end surface of the lens barrel to an object-side surface of the first spacing piece along the optical axis and an axial distance SAG11 from an intersection point of an object-side surface of the first lens and the optical axis to a projection point of an effective radius vertex of the object-side surface of the first lens onto the optical axis satisfy: 1.2<EP01/|SAG11|<2.0.

According to an implementation of the present disclosure, the spacing piece group further comprises a fourth spacing piece, and the fourth spacing piece is placed between the fourth lens and the fifth lens and in at least partial contact with the fourth lens, where a spacing distance EP45 between an image-side surface of the fourth spacing piece and the object-side surface of the fifth spacing piece along the direction of the optical axis, and an axial distance SAG51 from an intersection point of an object-side surface of the fifth lens and the optical axis to a projection point of an effective radius vertex of the object-side surface of the fifth lens onto the optical axis, satisfy: 0.5<EP45/|SAG51|<1.3.

According to an implementation of the present disclosure, the spacing piece group further comprises a fourth spacing piece, and the fourth spacing piece is placed between the fourth lens and the fifth lens and in at least partial contact with the fourth lens, where an outer diameter D4s of an object-side surface of the fourth spacing piece, a maximal effective radius DT32 of an image-side surface of the third lens, and a maximal thickness CP4 of the fourth spacing piece along the direction of the optical axis satisfy: 11<(D4s−DT32)/CP4<20.5.

According to an implementation of the present disclosure, an inner diameter d6m of an image-side surface of the sixth spacing piece, a radius of curvature R12 of an image-side surface of the sixth lens, an effective focal length f6 of the sixth lens, and the maximal thickness CP6 of the sixth spacing piece along the direction of the optical axis satisfy:

$$31 < d 6 m / R 12 * ( f 6 / CP 6 ) < 66 .$$

According to an implementation of the present disclosure, the maximal thickness CP6 of the sixth spacing piece along the direction of the optical axis, a spacing distance T67 between the sixth lens and the seventh lens on the optical axis, an axial distance SAG71 from an intersection point of an object-side surface of the seventh lens and the optical axis to a projection point of an effective radius vertex of the object-side surface of the seventh lens onto the optical axis, and an axial distance SAG62 from an intersection point of an image-side surface of the sixth lens and the optical axis to a projection point of an effective radius vertex of the image-side surface of the sixth lens onto the optical axis satisfy: 1.0≤(T67−CP6)/(|SAG71|−|SAG62|)<1.6.

According to an implementation of the present disclosure, an inner diameter d5m of an image-side surface of the fifth spacing piece, the inner diameter d5s of the object-side surface of the fifth spacing piece, and a radius of curvature R11 of an object-side surface of the sixth lens satisfy: 0.15<(d5m−d5s)/R11<0.6.

According to an implementation of the present disclosure, the inner diameter d5s of the object-side surface of the fifth spacing piece and a radius of curvature R11 of an object-side surface of the sixth lens satisfy: 2.0<d5s/R11<3.2.

According to an implementation of the present disclosure, the maximal thickness CP6 of the sixth spacing piece along the direction of the optical axis, and a spacing distance T67 between the sixth lens and the seventh lens on the optical axis satisfy:

$$0.4 < CP 6 / T 67 < 0.7 .$$

According to an implementation of the present disclosure, a combined focal length f56 of the fifth lens and the sixth lens, a radius of curvature R12 of an image-side surface of the sixth lens, a center thickness CT5 of the fifth lens on the optical axis, and a maximal thickness CP5 of the fifth spacing piece along the direction of the optical axis satisfy:

$$1.3 < f 56 / R 12 * ( CP 5 / CT 5 ) < 3.8 .$$

According to an implementation of the present disclosure, an inner diameter d0s of an object-side surface of the lens barrel, an inner diameter d0m of an image-side surface of the lens barrel, and an effective focal length f7 of the seventh lens satisfy: −1.5<(d0m−d0s)/f7<−1.2.

The optical imaging lens assembly provided in implementations of the present disclosure includes an optical lens group, a spacing piece group, and a lens barrel. The optical lens group includes a first lens, a second lens, a third lens, a fourth lens, a fifth lens, a sixth lens and a seventh lens that are sequentially arranged along an optical axis from an object side to an image side. The spacing piece group includes a fifth spacing piece and a sixth spacing piece, where the fifth spacing piece is placed between the fifth lens and the sixth lens and in at least partial contact with the fifth lens, and the sixth spacing piece is placed between the sixth lens and the seventh lens and in at least partial contact with the sixth lens. The maximal thickness CP6 of the sixth spacing piece along a direction of the optical axis is greater than a center thickness CT6 of the sixth lens on the optical axis, so that the strength of the sixth lens can be effectively enhanced and the optical imaging lens assembly is prevented from being deformed during assembling, but this will also cause the light in the edge field of the sixth lens to be too high, causing poor stray light. Therefore, by controlling an inner diameter d5s of an object-side surface of the fifth spacing piece, an inner diameter d6s of an object-side surface of the sixth spacing piece, and a spacing distance T56 between the fifth lens and the sixth lens on the optical axis to satisfy 4.5<(d6s−d5s)/T56<8.0, it can effectively improve the stray light deflected from the sixth lens to the fifth spacing piece and/or the sixth spacing piece, thereby improving the imaging quality of the optical imaging lens assembly.

### BRIEF DESCRIPTION OF THE DRAWINGS

Other features, objectives and advantages of the present disclosure will become more apparent through the detailed descriptions of non-limiting embodiments given with reference to the following accompanying drawings.

FIG. 1A is a marking diagram of parameters of an optical imaging lens assembly according to embodiments of the present disclosure;

FIG. 1B is a trend diagram of stray light at a position, that is away from an optical axis, of a sixth lens of the optical imaging lens assembly according to an embodiment of the present disclosure;

FIG. 2A is a diagram of total spots of stray light when an optical imaging lens assembly satisfies (d6s−d5s)/T56=2.88;

FIG. 2B is a related optical path diagram of a spot with maximal energy when the optical imaging lens assembly satisfies (d6s−d5s)/T56=2.88;

FIG. 2C is a related optical path diagram of a spot with secondary energy when the optical imaging lens assembly satisfies (d6s−d5s)/T56=2.88;

FIG. 2D is a diagram of total spots of stray light when an optical imaging lens assembly satisfies (d6s−d5s)/T56=8.31;

FIG. 2E is a related optical path diagram of a spot with maximal energy when the optical imaging lens assembly satisfies (d6s−d5s)/T56=8.31;

FIG. 2F is a related optical path diagram of a spot with secondary energy when the optical imaging lens assembly satisfies (d6s−d5s)/T56=8.31;

FIG. 2G is a diagram of total spots of stray light when an optical imaging lens assembly satisfies (d6s−d5s)/T56=6.72;

FIG. 3 is a schematic structural diagram of an optical imaging lens assembly according to Embodiment 1 of the present disclosure;

FIG. 4 is a schematic structural diagram of an optical imaging lens assembly according to Embodiment 2 of the present disclosure;

FIG. 5 is a schematic structural diagram of an optical imaging lens assembly according to Embodiment 3 of the present disclosure;

FIGS. 6A-6D respectively illustrate a longitudinal aberration curve, an astigmatic curve, a distortion curve and a lateral color curve of the optical imaging lens assembly according to Embodiment 1, 2 or 3 of the present disclosure;

FIG. 7 is a schematic structural diagram of an optical imaging lens assembly according to Embodiment 4 of the present disclosure;

FIG. 8 is a schematic structural diagram of an optical imaging lens assembly according to Embodiment 5 of the present disclosure;

FIG. 9 is a schematic structural diagram of an optical imaging lens assembly according to Embodiment 6 of the present disclosure;

FIGS. 10A-10D respectively illustrate a longitudinal aberration curve, an astigmatic curve, a distortion curve and a lateral color curve of the optical imaging lens assembly according to Embodiment 4, 5 or 6 of the present disclosure;

FIG. 11 is a schematic structural diagram of an optical imaging lens assembly according to Embodiment 7 of the present disclosure;

FIG. 12 is a schematic structural diagram of an optical imaging lens assembly according to Embodiment 8 of the present disclosure;

FIG. 13 is a schematic structural diagram of an optical imaging lens assembly according to Embodiment 9 of the present disclosure; and

FIGS. 14A-14D respectively illustrate a longitudinal aberration curve, an astigmatic curve, a distortion curve and a lateral color curve of the optical imaging lens assembly according to Embodiment 7, 8 or 9 of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements.

It should be noted that, in the specification, the expressions such as “first,” “second” and “third” are only used to distinguish one feature from another, rather than represent any limitations to the features. Thus, without departing from the teachings of the present disclosure, the first lens discussed below may also be referred to as the second lens or the third lens.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. A surface of each lens that is closest to a photographed object is referred to as the object-side surface of the lens, and a surface of each lens that is closest to an image plane is referred to as the image-side surface of the lens.

It should be further understood that the terms “comprise” and/or “have,” when used in the specification, specify the presence of stated features, elements and/or components, but do not exclude the presence or addition of one or more other features, elements, components and/or combinations thereof. Further, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that embodiments in the present disclosure and the features in the embodiments may be combined with each other on a non-conflict basis. Embodiments of the present disclosure will be described below in detail with reference to the accompanying drawings.

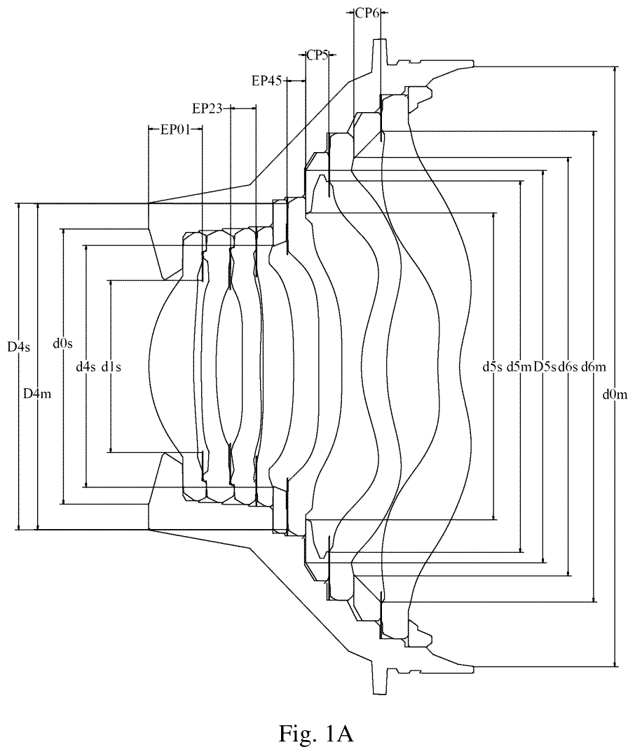

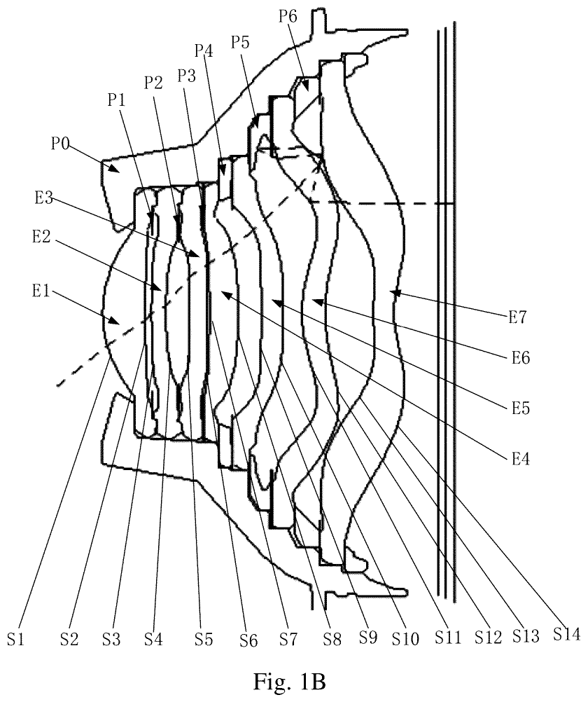

Referring to FIGS. 1A, 1B, 3-5, 7-9 and 11-13, an optical imaging lens assembly is provided in a first aspect of the present disclosure, and the optical imaging lens assembly may include an optical lens group. The optical lens group may sequentially include a first lens, a second lens, a third lens, a fourth lens, a fifth lens, a sixth lens and a seventh lens along an optical axis from an object side to an image side. The first to seventh lenses are sequentially arranged along the optical axis from the side of a photographed object to the side of an image plane, and each lens has at least an object-side surface facing the photographed object and an image-side surface facing the image plane.

There may be a spacing distance between any two adjacent lenses in the first to seventh lenses. For example, there may be an air spacing between two adjacent lenses.

The number of the lenses having refractive powers in optical imaging lens assembly is seven. In an exemplary implementation, the first lens, the fourth lens, the fifth lens and the sixth lens each has a positive refractive power, and the second lens, the third lens and the seventh lens each has a negative refractive power.

In an exemplary implementation, the optical imaging lens assembly may further include a spacing piece group. The spacing piece group includes one or more of: a first spacing piece, a second spacing piece, a third spacing piece, a fourth spacing piece, a fifth spacing piece, and a sixth spacing piece. The first spacing piece may be placed between an image-side surface of the first lens and the second lens and in at least partial contact with the image-side surface of the first lens. The second spacing piece may be placed between an image-side surface of the second lens and the third lens and in at least partial contact with the image-side surface of the second lens. The third spacing piece may be placed between an image-side surface of the third lens and the fourth lens and in at least partial contact with the image-side surface of the third lens. The fourth spacing piece may be placed between an image-side surface of the fourth lens and the fifth lens and in at least partial contact with the image-side surface of the fourth lens. The fifth spacing piece may be placed between an image-side surface of the fifth lens and the sixth lens and in at least partial contact with the image-side surface of the fifth lens. The sixth spacing piece may be placed between an image-side surface of the sixth lens and the seventh lens and in at least partial contact with the image-side surface of the sixth lens. The reasonable use of the spacing pieces can effectively avoid the risk of stray light, and reduce the interference with the image quality, thereby improving the imaging quality of the optical imaging lens assembly. Meanwhile, the stability of supporting the lenses can also be ensured.

In an exemplary implementation, the optical imaging lens assembly may further include a lens barrel, used to accommodate the optical lens group and the spacing piece group. The lens barrel includes an object-side end surface, an image-side end surface, an outer annular surface and an inner annular surface. The inner annular surface is stepped.

In an exemplary implementation, a maximal thickness CP6 of the sixth spacing piece along a direction of the optical axis is greater than a center thickness CT6 of the sixth lens on the optical axis, which can effectively enhance the strength of the sixth lens and prevent the optical imaging lens assembly from being deformed during assembling. However, it will also cause the light in the edge field of the sixth lens to be too high, causing poor stray light. Therefore, by controlling an inner diameter d5s of an object-side surface of the fifth spacing piece, an inner diameter d6s of an object-side surface of the sixth spacing piece, and a spacing distance T56 between the fifth lens and the sixth lens on the optical axis to satisfy 4.5<(d6s−d5s)/T56<8.0, it can effectively improve the stray light deflected from the sixth lens to the fifth spacing piece and/or the sixth spacing piece, thereby improving the imaging quality of the optical imaging lens assembly. Referring to the trend of the stray light at the position, that is away from the optical axis, of the sixth lens in FIG. 1B, 4.5<(d6s−d5s)/T56<8.0 is satisfied, and the stray light is blocked at the position of the fifth spacing piece. The dashed line in the drawing indicates the blocked stray light, which improves the stray light deflected from the sixth lens to the fifth spacing piece, thereby improving the imaging quality of the optical imaging lens assembly.

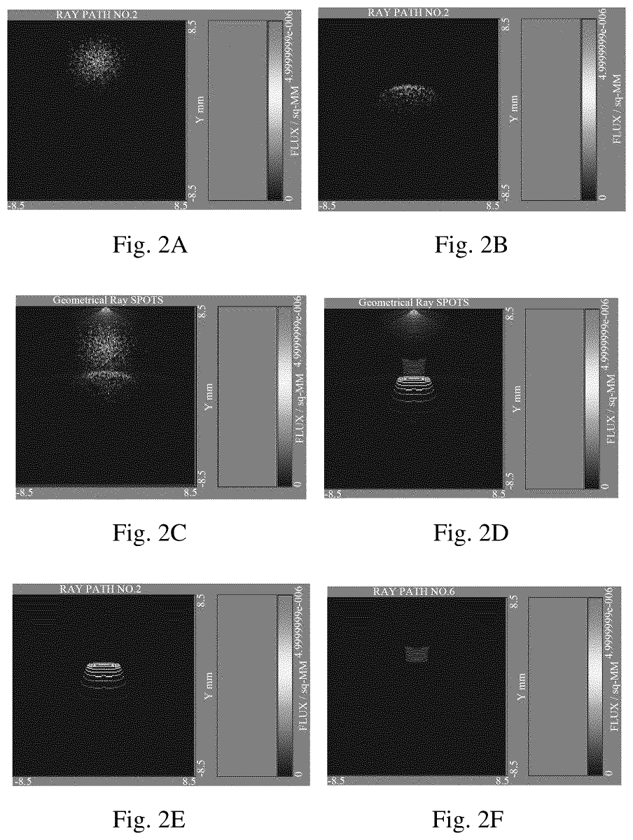

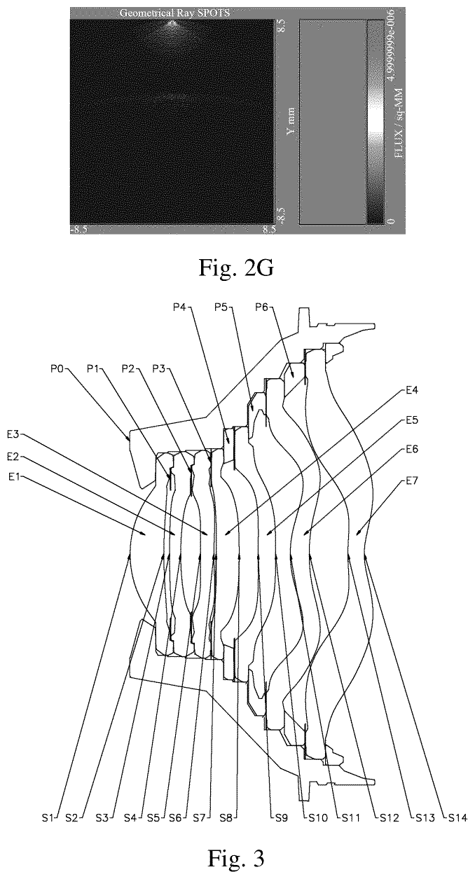

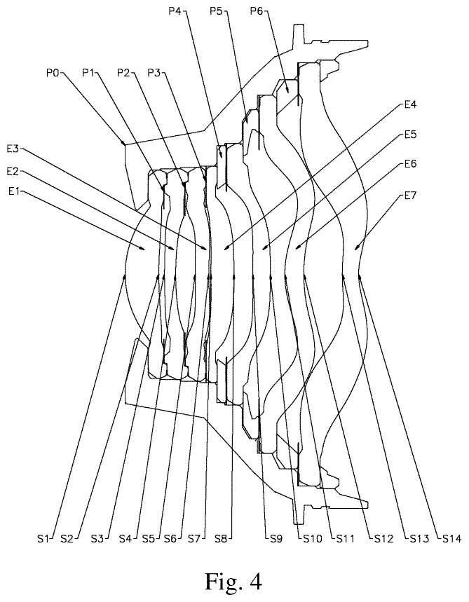

The details are further described in combination with FIGS. 2A-2G.

When (d6s−d5s)/T56<4.5 (e.g., (d6s−d5s)/T56=2.88), referring to FIGS. 2A-2C, FIG. 2A is a diagram of total spots of stray light, FIG. 2B is a related optical path diagram of a spot with maximal energy, and FIG. 2C is a related optical path diagram of a spot with secondary energy. It can be seen from FIG. 2B that the maximal energy intensity of the stray light is about 0.000001772 lm/mm², and the total energy intensity is about 0.000000448 lm. It can be seen from FIG. 2C that the maximal energy intensity of the stray light is about 0.000002342 lm/mm², and the total energy intensity is about 0.000000213 lm.

When (d6s−d5s)/T56>8 (e.g., (d6s−d5s)/T56=8.31), referring to FIGS. 2D-2F, FIG. 2D is a diagram of total spots of stray light, FIG. 2E is a related optical path diagram of a spot with maximal energy, and FIG. 2F is a related optical path diagram of a spot with secondary energy. It can be seen from FIG. 2E that the maximal energy intensity of the stray light is about 0.000009782 lm/mm², and the total energy intensity is about 0.000000778 lm. It can be seen from FIG. 2F that the maximal energy intensity of the stray light is about 0.000001231 lm/mm², and the total energy intensity is about 0.000000133 lm.

When 4.5<(d6s−d5s)/T56<8.0 (e.g., (d6s−d5s)/T56=6.72), referring to FIG. 2G, FIG. 2G is a diagram of total spots of stray light. It can be seen from FIG. 2G that the spot of the related optical path disappears, which effectively reduces the stray light, thereby improving the imaging quality of the optical imaging lens assembly.

In an exemplary implementation, when the spacing piece group includes the fourth spacing piece, an inner diameter d4s of an object-side surface of the fourth spacing piece and a maximal effective radius DT42 of the image-side surface of the fourth lens satisfy: 2.0<d4s/DT42<2.8. The inner diameter d4s of the object-side surface of the fourth spacing piece may be understood as the inner diameter of the object-side surface of the fourth spacing piece in the plane perpendicular to the optical axis. By controlling the ratio of the inner diameter of the object-side surface of the fourth spacing piece to the maximal effective radius of the image-side surface of the fourth lens within a reasonable range, the height of the light passing through the fourth lens can be effectively controlled. On the basis that the performance requirement for the optical system is ensured, the stray light deflected from the fourth lens to the fourth spacing piece can further be avoided, thereby improving the imaging quality of the optical imaging lens assembly.

In an exemplary implementation, when the spacing piece group includes the fourth spacing piece and the fifth spacing piece, a spacing distance EP45 between an image-side surface of the fourth spacing piece and the object-side surface of the fifth spacing piece along the direction of the optical axis, an outer diameter D5s of the object-side surface of the fifth spacing piece, and an outer diameter D4m of the image-side surface of the fourth spacing piece satisfy: 0.1<EP45/(D5s−D4m)<0.6. The outer diameter of the object-side surface of the fifth spacing piece may be understood as the outer diameter of the object-side surface of the fifth spacing piece in the plane perpendicular to the optical axis, and the outer diameter of the image-side surface of the fourth spacing piece may be understood as the outer diameter of the image-side surface of the fourth spacing piece in the plane perpendicular to the optical axis. By controlling this condition, the difference between the outer diameter of the object-side surface of the fifth spacing piece and the outer diameter of the image-side surface of the fourth spacing piece can be effectively controlled within a reasonable range, ensuring that the fifth spacing piece and the fourth spacing piece have the function of auxiliary support between the fifth spacing piece and the lens barrel while having sufficient common support. Accordingly, the large segment difference structure between the fifth lens and the sixth lens is improved, which improves the stability of assembling, thereby improving the yield.

In an exemplary implementation, when the spacing piece group includes a second spacing piece and a third spacing piece, a spacing distance EP23 between an image-side surface of the second spacing piece and an object-side surface of the third spacing piece along the direction of the optical axis and a center thickness CT3 of the third lens on the optical axis satisfy: 1.0<EP23/CT3<2.0. By controlling the ratio of the spacing distance between the image-side surface of the second spacing piece and the object-side surface of the third spacing piece along the direction of the optical axis to the center thickness of the third lens on the optical axis within a reasonable range, the uniformity of the overall thickness of the third lens can be ensured, which improves the stability of molding the third lens, thereby improving the yield of the lens assembly.

In an exemplary implementation, when the spacing piece group includes a first spacing piece, a radius of curvature R1 of an object-side surface of the first lens, a radius of curvature R2 of the image-side surface of the first lens, and an inner diameter d1s of an object-side surface of the first spacing piece satisfy: 3.0<(R1+R2)/d1s<4.5. The inner diameter of the object-side surface of the first spacing piece may be understood as the inner diameter of the object-side surface of the first spacing piece in the plane perpendicular to the optical axis. By controlling this condition, it can ensure that the light is guided by the first lens to be rapidly converged to reduce the aperture; and meanwhile, by controlling the inner diameter of the object-side surface of the first spacing piece, it can effectively block the stray light internally reflected by the first lens, thereby improving the imaging quality of the lens assembly.

In an exemplary implementation, when the spacing piece group includes a first spacing piece, a spacing distance EP01 from the object-side end surface of the lens barrel to the object-side surface of the first spacing piece along the optical axis and an axial distance SAG11 from an intersection point of the object-side surface of the first lens and the optical axis to a projection point of an effective radius vertex of the object-side surface of the first lens onto the optical axis satisfy: 1.2<EP01/|SAG11|<2.0. By controlling this condition, it helps the surface shapes of the object-side surface and the image-side surface of the first lens to reduce the intensity of the ghost image generated by the reflection of the two surfaces when the light passes through this lens at a specific incident angle, thereby improving the imaging quality of the optical system. Meanwhile, by controlling the spacing distance from the object-side end surface of the lens barrel to the object-side surface of the first spacing piece along the direction of the optical axis, it can ensure that the object-side surface of the first lens does not protrude from the object-side end surface of the lens barrel, which avoids scratches on the appearance of the lens, thereby improving the appearance yield.

In an exemplary implementation, when the spacing piece group includes a fifth spacing piece, an inner diameter d5m of an image-side surface of the fifth spacing piece, the inner diameter d5s of the object-side surface of the fifth spacing piece, and a radius of curvature R11 of an object-side surface of the sixth lens satisfy: 0.15<(d5m−d5s)/R11<0.6. The inner diameter of the image-side surface of the fifth spacing piece may be understood as the inner diameter of the image-side surface of the fifth spacing piece in the plane perpendicular to the optical axis, and the inner diameter of the object-side surface of the fifth spacing piece may be understood as the inner diameter of the object-side surface of the fifth spacing piece in the plane perpendicular to the optical axis. By controlling the radius of curvature of the object-side surface of the sixth lens, it helps to control the projection height of the light on the sixth lens, controlling the aperture of the sixth lens. However, it will cause the deflection angle of the light between the fifth lens and the sixth lens to be too large, resulting in primary reflected stray light deflected from the image-side surface of the fifth lens to the fifth spacing piece. By controlling the inner diameters of the object-side surface and the image-side surface of the fifth spacing piece, it helps to avoid the stray light, thereby improving the imaging quality of the optical imaging lens assembly.

In an exemplary implementation, when the spacing piece group includes a fifth spacing piece, the inner diameter d5s of the object-side surface of the fifth spacing piece and the radius of curvature R11 of the object-side surface of the sixth lens satisfy: 2.0<d5s/R11<3.2. The inner diameter of the object-side surface of the fifth spacing piece may be understood as the inner diameter of the object-side surface of the fifth spacing piece in the plane perpendicular to the optical axis. By controlling the radius of curvature of the object-side surface of the sixth lens, the deflection angle of the light can be reduced, thereby improving the imaging quality of the optical imaging lens assembly. In addition, by controlling the inner diameter of the fifth spacing piece close to the image side, it not only can effectively control the support width, but also to effectively block the stray light, thereby improving the imaging quality.

In an exemplary implementation, when the spacing piece group includes a fourth spacing piece and a fifth spacing piece, the spacing distance EP45 between the image-side surface of the fourth spacing piece and the object-side surface of the fifth spacing piece along the direction of the optical axis and an axial distance SAG51 from an intersection point of an object-side surface of the fifth lens and the optical axis to a projection point of an effective radius vertex of the object-side surface of the fifth lens onto the optical axis satisfy: 0.5<EP45/|SAG51|<1.3. By controlling this condition, the angle of the chief ray incident on the object-side surface of the fifth lens can be effectively reduced, and the degree of matching between the optical imaging lens assembly and the chip can be improved. Meanwhile, by controlling the spacing distance between the image-side surface of the fourth spacing piece and the object-side surface of the fifth spacing piece along the direction of the optical axis, it helps to control the edge thickness of the fifth lens, and helps to avoid the stray light reflected from the edge of the effective diameter of the fifth lens to the fifth spacing piece, thereby improving the imaging quality of the optical system.

In an exemplary implementation, when the spacing piece group includes a sixth spacing piece, the maximal thickness CP6 of the sixth spacing piece along the direction of the optical axis and a spacing distance T67 between the sixth lens and the seventh lens on the optical axis satisfy: 0.4<CP6/T67<0.7. By controlling this condition, it helps to reasonably distribute the center thicknesses and edge thicknesses of the sixth lens and the seventh lens, and helps to evenly distribute the lens size, which is conducive to reducing the difficulty in processing and assembling the lenses.

In an exemplary implementation, when the spacing piece group includes a fifth spacing piece, a combined focal length f56 of the fifth lens and the sixth lens, a radius of curvature R12 of the image-side surface of the sixth lens, a center thickness CT5 of the fifth lens on the optical axis, and a maximal thickness CP5 of the fifth spacing piece along the direction of the optical axis satisfy: 1.3<f56/R12*(CP5/CT5)<3.8, for example, 1.3<f56/R12*(CP5/CT5)<2.5. By controlling the maximal thickness of the fifth spacing piece along the optical axis and the center thickness of the fifth lens on the optical axis, it helps to ensure the uniformity of the overall thickness of the fifth lens, which improves the processability of the fifth lens. Meanwhile, by controlling the ratio of the combined focal length of the fifth lens and the sixth lens to the radius of curvature of the image-side surface of the sixth lens, it helps to correct the chromatic aberration of the system, and at the same time, the balance of various aberrations can be achieved.

In an exemplary implementation, an inner diameter d0s of an object-side surface of the lens barrel, an inner diameter d0m of an image-side surface of the lens barrel, and an effective focal length f7 of the seventh lens satisfy: −1.5<(d0m−d0s)/f7<−1.2. By controlling this condition, it helps to control the overall light height of the optical imaging lens assembly, and control the overall appearance size of the lens barrel, thereby achieving the miniaturization of the lens assembly.

In an exemplary implementation, when the spacing piece group includes a fourth spacing piece, an outer diameter D4s of the object-side surface of the fourth spacing piece, a maximal effective radius DT32 of the image-side surface of the third lens, and a maximal thickness CP4 of the fourth spacing piece along the direction of the optical axis satisfy: 11<(D4s−DT32)/CP4<20.5. By controlling this condition, it can ensure the strength of the fourth spacing piece, and ensure that the fourth spacing piece and the lens barrel play an auxiliary supporting role during the assembling of the fifth lens, which improves the stability of assembling of the optical imaging lens assembly, thereby increasing the yield. Meanwhile, by controlling the maximal effective radius of the image-side surface of the third lens, it helps to reduce the incident angle of edge light, and eliminate the segment difference from the first lens to the fourth lens during assembling, thereby improving the stability of assembling.

In an exemplary implementation, when the spacing piece group includes a sixth spacing piece, an inner diameter d6m of an image-side surface of the sixth spacing piece, the radius of curvature R12 of the image-side surface of the sixth lens, an effective focal length f6 of the sixth lens, and the maximal thickness CP6 of the sixth spacing piece along the direction of the optical axis satisfy: 31<d6m/R12*(f6/CP6)<66. By controlling the radius of curvature of the image-side surface of the sixth lens, the angle of light in the edge field can be controlled within a reasonable range, which can effectively reduce the sensitivity of the system. Meanwhile, the reasonable control for the sixth lens is conducive to improving the chromatic aberration, reducing the total track length of the system, and expanding the aperture of the system.

In an exemplary implementation, when the spacing piece group includes a sixth spacing piece, the maximal thickness CP6 of the sixth spacing piece along the direction of the optical axis, the spacing distance T67 between the sixth lens and the seventh lens on the optical axis, an axial distance SAG71 from an intersection point of an object-side surface of the seventh lens and the optical axis to a projection point of an effective radius vertex of the object-side surface of the seventh lens onto the optical axis, and an axial distance SAG62 from an intersection point of the image-side surface of the sixth lens and the optical axis to a projection point of an effective radius vertex of the image-side surface of the sixth lens onto the optical axis satisfy: 1.0≤(T67−CP6)/(|SAG71|−|SAG62|)<1.6. By controlling this condition, it helps to ensure that the lens has a greater refractive power for the off-axis field, which is conducive to shortening the overall length of the lens assembly and improving the resolution of the system.

In the implementations of the present disclosure, at least one of the surfaces of any lens in the first to seventh lenses is an aspheric surface. An aspheric lens is characterized in that the curvature continuously changes from the center of the lens to the periphery of the lens. Different from a spherical lens having a constant curvature from the center of the lens to the periphery of the lens, the aspheric lens has a better radius-of-curvature characteristic, and has advantages of improving the distortion aberration and improving the astigmatic aberration. The use of the aspheric lens can eliminate as much as possible the aberrations that occur during the imaging, thereby improving the imaging quality. Alternatively, the object-side surface and image-side surface of any lens in the first to seventh lenses are both aspheric surfaces.

The optical imaging lens assembly according to the above implementations of the present disclosure may use seven lenses, a lens barrel and a spacing piece group. By reasonably distributing the parameters of the lenses, the lens barrel and the spacing pieces, it may reduce stray light, and realize the characteristics of miniaturization and large image plane of the optical imaging lens assembly, which improves the imaging quality and stability of assembling of the optical imaging lens assembly.

It should be understood by those skilled in the art that the various results and advantages described in the present specification may be obtained by changing the numbers of the lenses and the spacing pieces that constitute the optical imaging lens assembly without departing from the technical solution claimed by the present disclosure.

Detailed embodiments of the optical imaging lens assembly that may be applicable to the above implementations are further described below with reference to the accompanying drawings.

### Embodiment 1

An optical imaging lens assembly according to Embodiment 1 of the present disclosure is described below with reference to FIG. 3.

As shown in FIG. 3, the optical imaging lens assembly includes an optical lens group, a spacing piece group and a lens barrel.

The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side. A diaphragm STO (not shown in FIG. 3) may be disposed on the object side of an object-side surface of the first lens E1.

The first lens E1 has a positive refractive power, the object-side surface S1 of the first lens E1 is a convex surface, and an image-side surface S2 of the first lens E1 is a concave surface. The second lens E2 has a negative refractive power, an object-side surface S3 of the second lens E2 is a convex surface, and an image-side surface S4 of the second lens E2 is a concave surface. The third lens E3 has a negative refractive power, an object-side surface S5 of the third lens E3 is a convex surface, and an image-side surface S6 of the third lens E3 is a concave surface. The fourth lens E4 has a positive refractive power, an object-side surface S7 of the fourth lens E4 is a convex surface, and an image-side surface S8 of the fourth lens E4 is a convex surface. The fifth lens E5 has a positive refractive power, an object-side surface S9 of the fifth lens E5 is a convex surface, and an image-side surface S10 of the fifth lens E5 is a convex surface. The sixth lens E6 has a positive refractive power, an object-side surface S11 of the sixth lens E6 is a convex surface, and an image-side surface S12 of the sixth lens E6 is a concave surface. The seventh lens E7 has a negative refractive power, an object-side surface S13 of the seventh lens E7 is a convex surface, and an image-side surface S14 of the seventh lens E7 is a concave surface. An optical filter or a protective glass has an object-side surface S15 (not shown) and an image-side surface S16 (not shown). Light from an object sequentially passes through the surfaces S1-S16, and finally forms an image on an image plane S17 (not shown).

The spacing piece group includes a first spacing piece P1, a second spacing piece P2, a third spacing piece P3, a fourth spacing piece P4, a fifth spacing piece P5 and a sixth spacing piece P6 that are placed in the lens barrel P0. In an example, the spacing pieces can block the entry of excess light to a next lens during imaging, and at the same time, can make the lenses better supported against the lens barrel P0, enhancing the structural stability of the optical imaging lens assembly.

Table 1 is a table showing basic parameters of the optical imaging lens assembly of Embodiment 1. Here, the units of a radius of curvature and a thickness/distance are millimeters (mm).

TABLE 1

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | | infinite | infinite | | | | |
| STO | | infinite | −0.4441 | | | | |
| S1 | aspheric | 3.5822 | 1.2322 | 1.55 | 56.14 | 8.65 | 0.0000 |
| S2 | aspheric | 13.0255 | 0.2093 | | | | 0.0000 |
| S3 | aspheric | 21.3916 | 0.4110 | 1.68 | 19.24 | −27.04 | 0.0000 |
| S4 | aspheric | 9.7865 | 0.7195 | | | | 0.0000 |
| S5 | aspheric | 27.7911 | 0.4968 | 1.68 | 19.24 | −30.01 | 0.0000 |
| S6 | aspheric | 11.6503 | 0.0811 | | | | 0.0000 |
| S7 | aspheric | 34.2362 | 0.8441 | 1.55 | 56.14 | 29.06 | 0.0000 |
| S8 | aspheric | −29.3082 | 0.6943 | | | | 0.0000 |
| S9 | aspheric | 57.6937 | 0.6370 | 1.57 | 37.40 | 86.13 | 0.0000 |
| S10 | aspheric | −327.5485 | 0.5372 | | | | 0.0000 |
| S11 | aspheric | 3.6602 | 0.6975 | 1.54 | 55.71 | 13.40 | −1.0000 |
| S12 | aspheric | 6.9580 | 1.4129 | | | | 0.0000 |
| S13 | aspheric | 5.9542 | 0.5995 | 1.54 | 55.71 | −8.32 | −1.0000 |
| S14 | aspheric | 2.4621 | 1.3368 | | | | −1.0000 |
| S15 | | infinite | 0.2100 | 1.52 | 64.20 | | 0.0000 |
| S16 | | infinite | 0.2508 | | | | 0.0000 |
| S17 | | infinite | 0.0000 | | | | |

In this embodiment, the object-side surface and the image-side surface of any lens in the first to seventh lenses E1-E7 are both aspheric surfaces, and the surface type x of each aspheric lens may be defined using, but not limited to, the following formula:

$$x = \frac{c {h}^{2}}{1 + \sqrt{1 - ( k + 1 ) {c}^{2} {h}^{2}}} + \sum Ai {h}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Table 2 shows the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S14 in Embodiment 1.

TABLE 2

| surface number | A4 | A6 | A8 | A10 | A12 | A14 | A16 |
|---|---|---|---|---|---|---|---|
| S1 | −1.1811E−02 | −9.5772E−03 | −4.0149E−03 | −1.1845E−03 | −3.5064E−04 | −1.1042E−04 | −4.8081E−05 |
| S2 | −9.7768E−02 | 5.9749E−03 | −3.4813E−03 | −6.2697E−04 | −4.7344E−04 | −1.8479E−04 | −5.3638E−05 |
| S3 | 3.1297E−02 | 3.8087E−02 | 7.6340E−04 | 1.4277E−03 | −1.8243E−04 | −1.2285E−04 | −5.7222E−05 |
| S4 | 6.5914E−02 | 2.0753E−02 | 1.4680E−03 | 1.8296E−03 | 5.6467E−04 | 2.5625E−04 | 1.2248E−04 |
| S5 | −2.8488E−01 | −1.5307E−02 | 1.5423E−04 | 1.6630E−03 | 5.4236E−04 | 1.9790E−04 | 6.4594E−05 |
| S6 | −4.1819E−01 | 2.1412E−02 | 5.3142E−03 | 4.3737E−03 | 2.2344E−03 | 4.1767E−04 | −1.9502E−04 |
| S7 | −2.5555E−01 | 2.8316E−02 | −1.0721E−02 | 7.4222E−05 | 2.8147E−03 | 3.3672E−04 | −2.1335E−04 |
| S8 | −4.4820E−01 | −2.2058E−02 | −1.5908E−02 | −3.2566E−03 | 1.8844E−03 | 1.5306E−03 | 6.5724E−04 |
| S9 | −8.3232E−01 | −6.9087E−02 | 3.2064E−03 | 1.2148E−02 | 4.5756E−03 | 1.7831E−03 | −1.2397E−04 |
| S10 | −1.0642E+00 | 3.0698E−01 | 4.1118E−04 | −9.6855E−03 | −1.4124E−02 | 2.0874E−03 | 3.1774E−03 |
| S11 | −4.7691E+00 | 6.6276E−01 | 2.2327E−01 | −8.3339E−02 | −3.1105E−02 | −7.1689E−04 | 1.4019E−02 |
| S12 | −3.5970E+00 | 9.4670E−02 | 1.6121E−01 | −1.0747E−01 | 7.1124E−02 | −1.9193E−03 | 6.2591E−03 |
| S13 | −6.5033E+00 | 2.6096E+00 | −1.1435E+00 | 4.5288E−01 | −1.4312E−01 | 2.1827E−02 | −3.0168E−03 |
| S14 | −1.2603E+01 | 3.2004E+00 | −9.3445E−01 | 3.8275E−01 | −1.9320E−01 | 6.1746E−02 | −2.6039E−02 |
| S15 | 0.0000E+00 | 0.0000E+00 | 0.0000E+00 | 0.0000E+00 | 0.0000E+00 | 0.0000E+00 | 0.0000E+00 |
| S16 | 0.0000E+00 | 0.0000E+00 | 0.0000E+00 | 0.0000E+00 | 0.0000E+00 | 0.0000E+00 | 0.0000E+00 |
| surface number | A18 | A20 | A22 | A24 | A26 | A28 | A30 |
| S1 | −2.1994E−05 | −8.2400E−06 | −3.1625E−06 | 3.4930E−07 | 2.1340E−06 | 3.8456E−06 | 2.4839E−06 |
| S2 | −5.2190E−06 | 6.7930E−06 | 5.8592E−06 | 1.4110E−06 | 1.0272E−06 | 0.0000E+00 | 0.0000E+00 |
| S3 | −2.7454E−05 | −8.1884E−06 | −2.8520E−06 | −2.5286E−06 | −2.1550E−07 | −3.4773E−07 | −1.7032E−07 |
| S4 | 5.0900E−05 | 2.3510E−05 | 8.8152E−06 | 1.6198E−06 | −1.1019E−06 | −3.7732E−06 | −4.2725E−06 |
| S5 | 2.6514E−05 | 1.1443E−05 | 4.4646E−06 | 2.9366E−06 | 1.9416E−06 | 6.6605E−07 | −1.4381E−06 |
| S6 | 7.1921E−05 | 7.9570E−05 | −2.7075E−05 | −2.0322E−05 | 3.2048E−06 | 4.3840E−06 | −7.3049E−06 |
| S7 | 2.4833E−04 | 8.1669E−05 | −9.0752E−05 | −2.2430E−05 | 1.6147E−05 | −3.5546E−06 | −1.3343E−05 |
| S8 | 2.7809E−04 | 1.1409E−04 | 2.2968E−05 | −4.5565E−06 | −1.0732E−05 | −6.7850E−06 | −4.5766E−06 |
| S9 | −9.4234E−04 | −6.7709E−04 | −2.8016E−04 | 2.7226E−05 | 1.0839E−04 | 7.6120E−05 | 3.6836E−05 |
| S10 | −5.0653E−04 | −3.4520E−04 | −1.3958E−04 | 1.9545E−04 | 7.7957E−06 | −9.9807E−06 | −9.5014E−06 |
| S11 | −2.1655E−03 | −9.0930E−04 | −4.3438E−04 | 2.9309E−04 | −1.3678E−04 | 1.4724E−04 | −3.6426E−05 |
| S12 | −9.2712E−03 | 1.8299E−04 | −1.8530E−03 | −7.7885E−04 | 1.1993E−04 | 5.5741E−04 | 1.8419E−04 |
| S13 | 5.1351E−03 | −7.6268E−03 | 4.5444E−03 | −5.7562E−04 | −1.0547E−03 | 9.0417E−04 | −2.4811E−04 |
| S14 | 2.0742E−02 | −1.4365E−02 | 3.3831E−03 | −1.1411E−05 | 1.2969E−03 | −5.3351E−04 | 9.2510E−05 |
| S15 | 0.0000E+00 | 0.0000E+00 | 0.0000E+00 | 0.0000E+00 | 0.0000E+00 | 0.0000E+00 | 0.0000E+00 |
| S16 | 0.0000E+00 | 0.0000E+00 | 0.0000E+00 | 0.0000E+00 | 0.0000E+00 | 0.0000E+00 | 0.0000E+00 |

For other parameters in Embodiment 1, reference is made to Tables 7 and 8.

### Embodiment 2

An optical imaging lens assembly according to Embodiment 2 of the present disclosure is described below with reference to FIG. 4.

As shown in FIG. 4, the optical imaging lens assembly includes an optical lens group, a spacing piece group and a lens barrel. The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side.

The table of the basic parameters of the optical imaging lens assembly in this embodiment is the same as Table 1, and the table of the coefficients of the aspheric surfaces is the same as Table 2. This embodiment differs from Embodiment 1 in that: the structure sizes of at least some elements in the spacing piece group are different from those in Embodiment 1. For example, the structure size of the inner diameter d5s of the object-side surface of the fifth spacing piece is different from that in Embodiment 1, and the structure size of the inner diameter d6s of the object-side surface of the sixth spacing piece is different from that in Embodiment 1. For details, reference may be made to the data corresponding to Embodiment 2 in Table 8.

### Embodiment 3

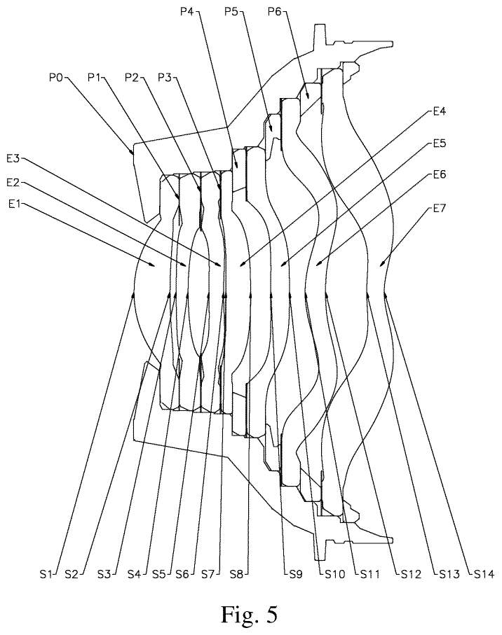

An optical imaging lens assembly according to Embodiment 3 of the present disclosure is described below with reference to FIG. 5.

As shown in FIG. 5, the optical imaging lens assembly includes an optical lens group, a spacing piece group and a lens barrel. The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side.

The table of the basic parameters of the optical imaging lens assembly in this embodiment is the same as Table 1, and the table of the coefficients of the aspheric surfaces is the same as Table 2. This embodiment differs from Embodiment 1 in that: the structure sizes of at least some elements in the spacing piece group are different from those in Embodiment 1. For example, the structure size of the inner diameter d5s of the object-side surface of the fifth spacing piece is different from that in Embodiment 1, and the structure size of the inner diameter d6s of the object-side surface of the sixth spacing piece is different from that in Embodiment 1. For details, reference may be made to the data corresponding to Embodiment 3 in Table 8.

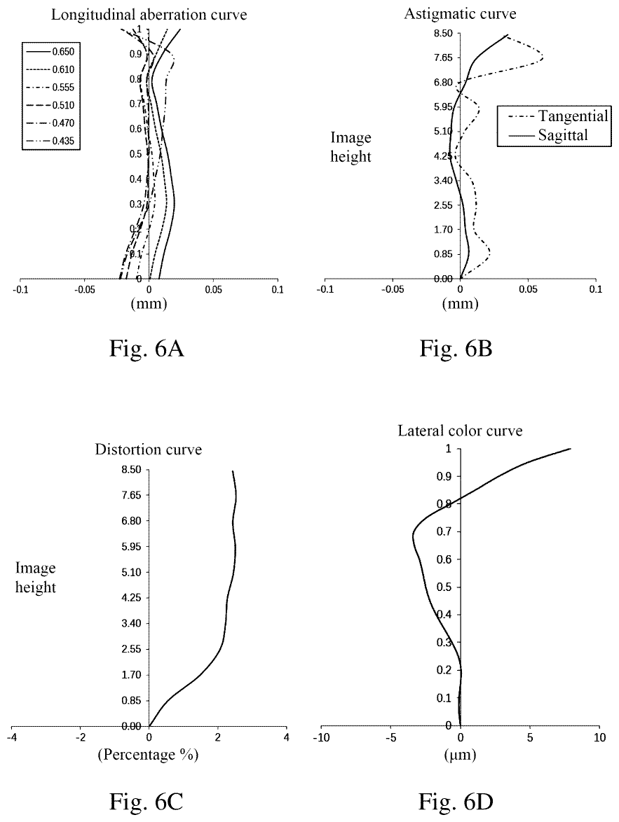

Referring to FIGS. 6A-6D, FIG. 6A illustrates a longitudinal aberration curve of the optical imaging lens assembly of Embodiment 1, 2 or 3, representing deviations of focal points of light of different wavelengths converged after passing through the optical imaging lens assembly. FIG. 6B illustrates an astigmatic curve of the optical imaging lens assembly of Embodiment 1, 2 or 3, representing a curvature of a tangential image plane and a curvature of a sagittal image plane that correspond to a different image height. FIG. 6C illustrates a distortion curve of the optical imaging lens assembly of Embodiment 1, 2 or 3, representing amounts of distortion corresponding to different image heights. FIG. 6D illustrates a lateral color curve of the optical imaging lens assembly of Embodiment 1, 2 or 3, representing deviations of different image heights on the image plane after light passes through the lens assembly. It can be seen from FIGS. 6A-6D that the optical imaging lens assembly given in Embodiments 1, 2 or 3 can achieve a good imaging quality.

### Embodiment 4

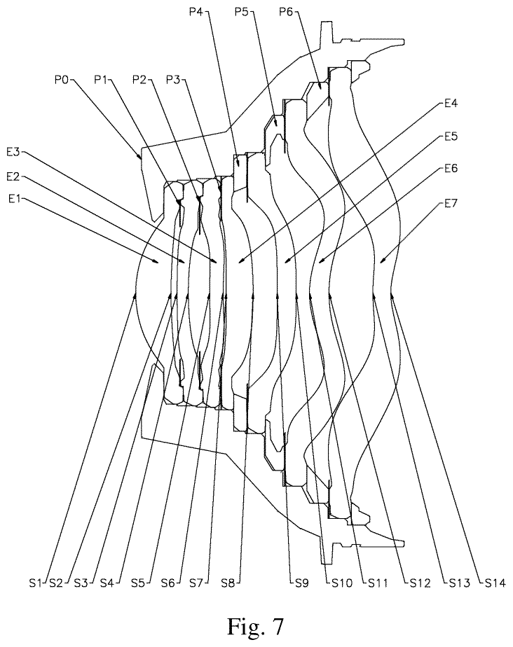

An optical imaging lens assembly according to Embodiment 4 of the present disclosure is described below with reference to FIG. 7.

As shown in FIG. 7, the optical imaging lens assembly includes an optical lens group, a spacing piece group and a lens barrel.

The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side. A diaphragm STO (not shown in FIG. 7) may be disposed on the object side of an object-side surface of the first lens E1.

The first lens E1 has a positive refractive power, the object-side surface S1 of the first lens E1 is a convex surface, and an image-side surface S2 of the first lens E1 is a concave surface. The second lens E2 has a negative refractive power, an object-side surface S3 of the second lens E2 is a convex surface, and an image-side surface S4 of the second lens E2 is a concave surface. The third lens E3 has a negative refractive power, an object-side surface S5 of the third lens E3 is a convex surface, and an image-side surface S6 of the third lens E3 is a concave surface. The fourth lens E4 has a positive refractive power, an object-side surface S7 of the fourth lens E4 is a convex surface, and an image-side surface S8 of the fourth lens E4 is a convex surface. The fifth lens E5 has a positive refractive power, an object-side surface S9 of the fifth lens E5 is a concave surface, and an image-side surface S10 of the fifth lens E5 is a convex surface. The sixth lens E6 has a positive refractive power, an object-side surface S11 of the sixth lens E6 is a convex surface, and an image-side surface S12 of the sixth lens E6 is a concave surface. The seventh lens E7 has a negative refractive power, an object-side surface S13 of the seventh lens E7 is a convex surface, and an image-side surface S14 of the seventh lens E7 is a concave surface. An optical filter or a protective glass has an object-side surface S15 (not shown) and an image-side surface S16 (not shown). Light from an object sequentially passes through the surfaces S1-S16, and finally forms an image on an image plane S17 (not shown).

The spacing piece group includes a first spacing piece P1, a second spacing piece P2, a third spacing piece P3, a fourth spacing piece P4, a fifth spacing piece P5 and a sixth spacing piece P6 that are placed in the lens barrel P0. In an example, the spacing pieces can block the entry of excess light to a next lens during imaging, and at the same time, can make the lenses better supported against the lens barrel P0, enhancing the structural stability of the optical imaging lens assembly.

Table 3 is a table showing basic parameters of the optical imaging lens assembly of Embodiment 4. Here, the units of a radius of curvature and a thickness/distance are millimeters (mm).

TABLE 3

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | | infinite | infinite | | | | |
| STO | | infinite | −0.6272 | | | | |
| S1 | aspheric | 3.6055 | 1.1782 | 1.55 | 56.14 | 8.51 | 0.0000 |
| S2 | aspheric | 14.2731 | 0.2023 | | | | 0.0000 |
| S3 | aspheric | 24.5348 | 0.3748 | 1.68 | 19.24 | −23.98 | 0.0000 |
| S4 | aspheric | 9.7081 | 0.7115 | | | | 0.0000 |
| S5 | aspheric | 17.4412 | 0.4505 | 1.68 | 19.24 | −39.98 | 0.0000 |
| S6 | aspheric | 10.4960 | 0.1031 | | | | 0.0000 |
| S7 | aspheric | 155.7543 | 0.8970 | 1.55 | 56.14 | 25.28 | 0.0000 |
| S8 | aspheric | −15.1104 | 0.8040 | | | | 0.0000 |
| S9 | aspheric | −258.5051 | 0.6328 | 1.57 | 37.40 | 373.45 | 0.0000 |
| S10 | aspheric | −116.8312 | 0.4454 | | | | 0.0000 |
| S11 | aspheric | 3.1089 | 0.6516 | 1.54 | 55.71 | 15.68 | −1.0000 |
| S12 | aspheric | 4.5699 | 1.4613 | | | | −1.0000 |
| S13 | aspheric | 5.0426 | 0.6000 | 1.54 | 55.71 | −9.19 | −1.0000 |
| S14 | aspheric | 2.3894 | 1.0975 | | | | −1.0000 |
| S15 | | infinite | 0.3000 | 1.52 | 64.20 | | 0.0000 |
| S16 | | infinite | 0.4500 | | | | 0.0000 |
| S17 | | infinite | 0.0000 | | | | |

In this embodiment, the object-side surface and the image-side surface of any lens in the first to seventh lenses E1-E7 are both aspheric surfaces, and the surface type x of each aspheric lens may be defined using, but not limited to, the following formula:

$$x = \frac{c {h}^{2}}{1 + \sqrt{1 - ( k + 1 ) {c}^{2} {h}^{2}}} + \sum Ai {h}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 3 above); k is the conic coefficient; and Ai is the correction coefficient of an i-th order of the aspheric surface. Table 4 shows the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S14 in Embodiment 4.

TABLE 4

| surface number | A4 | A6 | A8 | A10 | A12 | A14 | A16 |
|---|---|---|---|---|---|---|---|
| S1 | 1.0315E−03 | −4.0123E−03 | −2.7087E−03 | −9.7884E−04 | −3.2527E−04 | −6.3906E−05 | −2.5090E−05 |
| S2 | −5.2139E−02 | 6.3721E−03 | −3.2617E−03 | 3.9571E−04 | −6.4890E−06 | −3.7830E−05 | −2.6098E−05 |
| S3 | 2.7713E−02 | 2.4771E−02 | −7.3853E−04 | 2.1429E−03 | 2.1299E−04 | 5.3632E−05 | −2.8959E−07 |
| S4 | 4.0850E−02 | 1.6213E−02 | 1.1897E−03 | 2.2741E−03 | 6.7505E−04 | 2.7844E−04 | 1.0145E−04 |
| S5 | −3.0247E−01 | −7.9621E−04 | 2.1864E−03 | 2.1966E−03 | 7.3541E−04 | 2.1627E−04 | 4.4014E−05 |
| S6 | −4.0383E−01 | 2.8710E−02 | 7.4566E−03 | 4.7148E−03 | 2.5809E−03 | 1.1938E−04 | −2.5578E−04 |
| S7 | −1.6587E−01 | 4.3798E−03 | −4.5089E−03 | 2.9118E−03 | 3.7922E−03 | 3.0393E−05 | −3.5915E−04 |
| S8 | −3.7195E−01 | −4.3881E−02 | −1.0115E−02 | 3.5004E−03 | 5.4414E−03 | 2.5222E−03 | 5.3809E−04 |
| S9 | −8.4490E−01 | −8.8722E−02 | 2.7213E−02 | 2.1415E−02 | 4.6523E−03 | −2.0776E−03 | −3.3864E−03 |
| S10 | −1.1175E+00 | 3.6447E−01 | −4.3596E−03 | −2.6702E−02 | −1.8863E−02 | 8.7502E−03 | 4.4965E−03 |
| S11 | −5.9229E+00 | 1.1675E+00 | 1.1775E−01 | −1.5113E−01 | −1.4234E−02 | 2.6584E−02 | 7.7799E−03 |
| S12 | −4.2990E+00 | 3.3795E−01 | 1.5703E−01 | −8.3438E−02 | 5.4435E−02 | 3.5146E−03 | 6.6381E−03 |
| S13 | −7.2765E+00 | 2.8337E+00 | −1.2198E+00 | 4.7106E−01 | −1.5948E−01 | 3.4788E−02 | −1.6645E−02 |
| S14 | −1.3614E+01 | 3.6801E+00 | −1.1528E+00 | 3.9905E−01 | −2.0765E−01 | 7.3905E−02 | −3.7305E−02 |
| S15 | 0.0000E+00 | 0.0000E+00 | 0.0000E+00 | 0.0000E+00 | 0.0000E+00 | 0.0000E+00 | 0.0000E+00 |
| S16 | 0.0000E+00 | 0.0000E+00 | 0.0000E+00 | 0.0000E+00 | 0.0000E+00 | 0.0000E+00 | 0.0000E+00 |
| surface number | A18 | A20 | A22 | A24 | A26 | A28 | A30 |
| S1 | −1.8241E−06 | −9.3161E−06 | −3.6980E−06 | −5.5241E−06 | −3.1223E−06 | −5.2117E−06 | −1.8199E−06 |
| S2 | −1.0493E−05 | 2.5830E−06 | 4.5497E−06 | 4.9951E−06 | 3.4293E−06 | 0.0000E+00 | 0.0000E+00 |
| S3 | −8.6535E−06 | 2.6629E−07 | −6.7667E−07 | 1.6383E−06 | 2.5532E−06 | 1.5785E−06 | 1.2950E−06 |
| S4 | 2.7401E−05 | 4.2871E−06 | −8.0660E−06 | −9.7053E−06 | −8.3643E−06 | −5.8957E−06 | −2.6405E−06 |
| S5 | 1.1389E−05 | −5.4966E−07 | 1.3865E−06 | −2.7577E−07 | 4.8959E−07 | −2.1537E−06 | −1.0041E−06 |
| S6 | 1.7608E−05 | 3.7365E−05 | −1.2625E−05 | 9.0733E−06 | 4.1543E−06 | −6.8149E−06 | −9.5046E−06 |
| S7 | 7.3517E−05 | −1.7578E−05 | −4.5069E−05 | 2.5753E−05 | 1.3549E−05 | −1.2344E−05 | −8.5580E−06 |
| S8 | −1.2271E−04 | −2.5797E−04 | −2.0189E−04 | −1.0924E−04 | −3.4557E−05 | −2.2141E−06 | 5.4280E−06 |
| S9 | −2.2166E−03 | −5.3529E−04 | 3.2127E−04 | 4.3731E−04 | 2.4472E−04 | 6.4516E−05 | −2.2679E−06 |
| S10 | −1.6850E−03 | −1.0802E−03 | 2.0137E−04 | 5.0853E−04 | −1.8624E−05 | −1.7417E−04 | −8.4687E−05 |
| S11 | −8.3620E−03 | −6.9364E−04 | 1.4027E−03 | 5.7343E−04 | −3.3299E−04 | −4.6662E−05 | 9.6059E−05 |
| S12 | −1.1366E−02 | −1.1234E−03 | −4.3374E−04 | 1.5885E−04 | −1.2719E−04 | 1.0561E−04 | 2.6488E−04 |
| S13 | 1.2326E−02 | −8.7130E−03 | 2.9938E−03 | 5.0909E−05 | −3.3199E−04 | 1.2533E−04 | 8.3288E−05 |
| S14 | 2.8864E−02 | −1.7847E−02 | 8.4463E−03 | 1.8519E−03 | 1.3151E−03 | −1.5111E−03 | 1.1560E−03 |
| S15 | 0.0000E+00 | 0.0000E+00 | 0.0000E+00 | 0.0000E+00 | 0.0000E+00 | 0.0000E+00 | 0.0000E+00 |
| S16 | 0.0000E+00 | 0.0000E+00 | 0.0000E+00 | 0.0000E+00 | 0.0000E+00 | 0.0000E+00 | 0.0000E+00 |

For other parameters in Embodiment 4, reference is made to Tables 7 and 8.

### Embodiment 5

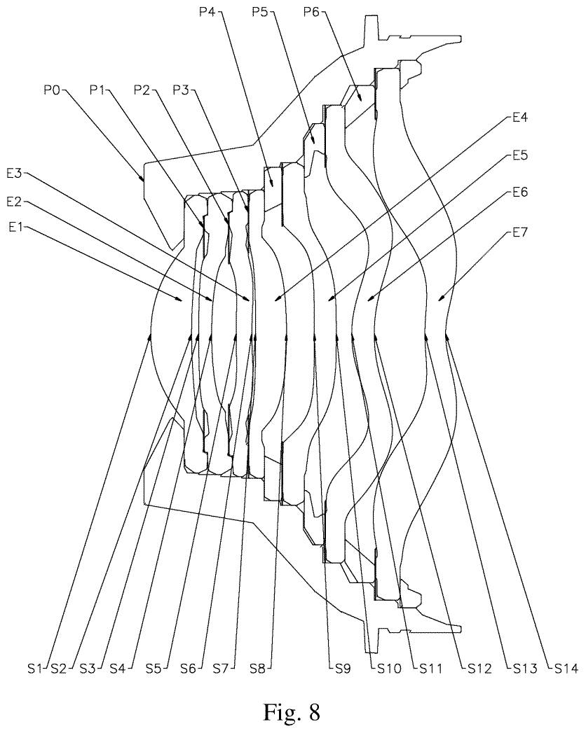

An optical imaging lens assembly according to Embodiment 5 of the present disclosure is described below with reference to FIG. 8.

As shown in FIG. 8, the optical imaging lens assembly includes an optical lens group, a spacing piece group and a lens barrel. The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side.

The table of the basic parameters of the optical imaging lens assembly in this embodiment is the same as Table 3, and the table of the coefficients of the aspheric surfaces is the same as Table 4. This embodiment differs from Embodiment 4 in that: the structure sizes of at least some elements in the spacing piece group are different from those in Embodiment 4. For example, the structure size of the inner diameter d5s of the object-side surface of the fifth spacing piece is different from that in Embodiment 4, and the structure size of the inner diameter d6s of the object-side surface of the sixth spacing piece is different from that in Embodiment 4. For details, reference may be made to the data corresponding to Embodiment 5 in Table 8.

### Embodiment 6

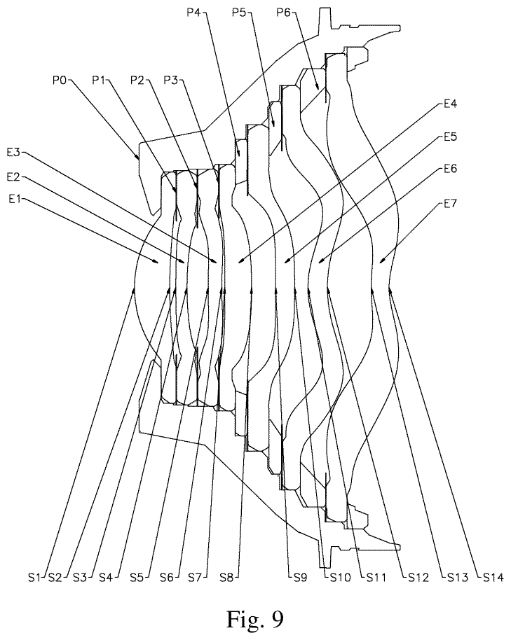

An optical imaging lens assembly according to Embodiment 6 of the present disclosure is described below with reference to FIG. 9.

As shown in FIG. 9, the optical imaging lens assembly includes an optical lens group, a spacing piece group and a lens barrel. The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side.

The table of the basic parameters of the optical imaging lens assembly in this embodiment is the same as Table 3, and the table of the coefficients of the aspheric surfaces is the same as Table 4. This embodiment differs from Embodiment 4 in that: the structure sizes of at least some elements in the spacing piece group are different from those in Embodiment 4. For example, the structure size of the inner diameter d5s of the object-side surface of the fifth spacing piece is different from that in Embodiment 4, and the structure size of the inner diameter d6s of the object-side surface of the sixth spacing piece is different from that in Embodiment 4. For details, reference may be made to the data corresponding to Embodiment 6 in Table 8.

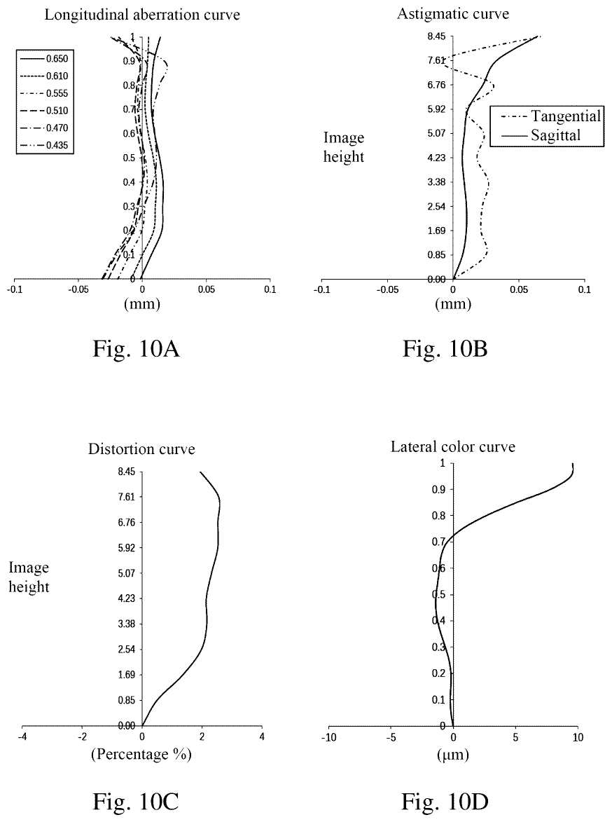

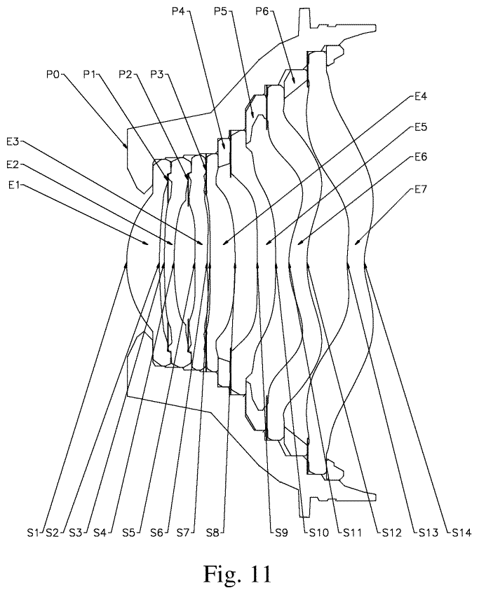

Referring to FIGS. 10A-10D, FIG. 10A illustrates a longitudinal aberration curve of the optical imaging lens assembly of Embodiment 4, 5 or 6, representing deviations of focal points of light of different wavelengths converged after passing through the optical imaging lens assembly. FIG. 10B illustrates an astigmatic curve of the optical imaging lens assembly of Embodiment 4, 5 or 6, representing a curvature of a tangential image plane and a curvature of a sagittal image plane that correspond to a different image height. FIG. 10C illustrates a distortion curve of the optical imaging lens assembly of Embodiment 4, 5 or 6, representing amounts of distortion corresponding to different image heights. FIG. 10D illustrates a lateral color curve of the optical imaging lens assembly of Embodiment 4, 5 or 6, representing deviations of different image heights on the image plane after light passes through the lens assembly. It can be seen from FIGS. 10A-10D that the optical imaging lens assembly given in Embodiments 4, 5 or 6 can achieve a good imaging quality.

### Embodiment 7

An optical imaging lens assembly according to Embodiment 7 of the present disclosure is described below with reference to FIG. 11.

As shown in FIG. 11, the optical imaging lens assembly includes an optical lens group, a spacing piece group and a lens barrel.

The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side. A diaphragm STO (not shown in FIG. 11) may be disposed on the object side of an object-side surface of the first lens E1.

The first lens E1 has a positive refractive power, the object-side surface S1 of the first lens E1 is a convex surface, and an image-side surface S2 of the first lens E1 is a concave surface. The second lens E2 has a negative refractive power, an object-side surface S3 of the second lens E2 is a convex surface, and an image-side surface S4 of the second lens E2 is a concave surface. The third lens E3 has a negative refractive power, an object-side surface S5 of the third lens E3 is a convex surface, and an image-side surface S6 of the third lens E3 is a concave surface. The fourth lens E4 has a positive refractive power, an object-side surface S7 of the fourth lens E4 is a convex surface, and an image-side surface S8 of the fourth lens E4 is a convex surface. The fifth lens E5 has a positive refractive power, an object-side surface S9 of the fifth lens E5 is a convex surface, and an image-side surface S10 of the fifth lens E5 is a convex surface. The sixth lens E6 has a positive refractive power, an object-side surface S11 of the sixth lens E6 is a convex surface, and an image-side surface S12 of the sixth lens E6 is a concave surface. The seventh lens E7 has a negative refractive power, an object-side surface S13 of the seventh lens E7 is a convex surface, and an image-side surface S14 of the seventh lens E7 is a concave surface. An optical filter or a protective glass has an object-side surface S15 (not shown) and an image-side surface S16 (not shown). Light from an object sequentially passes through the surfaces S1-S16, and finally forms an image on an image plane S17 (not shown).

The spacing piece group includes a first spacing piece P1, a second spacing piece P2, a third spacing piece P3, a fourth spacing piece P4, a fifth spacing piece P5 and a sixth spacing piece P6 that are placed in the lens barrel P0. In an example, the spacing pieces can block the entry of excess light to a next lens during imaging, and at the same time, can make the lenses better supported against the lens barrel P0, enhancing the structural stability of the optical imaging lens assembly.

Table 5 is a table showing basic parameters of the optical imaging lens assembly of Embodiment 7. Here, the units of a radius of curvature and a thickness/distance are millimeters (mm).

TABLE 5

| | | | | material | | | |
|---|---|---|---|---|---|---|---|
| surface | surface | radius of | thickness/ | refractive | abbe | focal | conic |
| number | type | curvature | distance | index | number | length | coefficient |
| OBJ | | infinite | infinite | | | | |
| STO | | infinite | −0.6302 | | | | |
| S1 | aspheric | 3.6223 | 1.1741 | 1.55 | 56.14 | 8.48 | 0.0000 |
| S2 | aspheric | 14.7306 | 0.1756 | | | | 0.0000 |
| S3 | aspheric | 20.5982 | 0.3478 | 1.68 | 19.24 | −24.01 | 0.0000 |
| S4 | aspheric | 9.0228 | 0.7429 | | | | 0.0000 |
| S5 | aspheric | 18.4343 | 0.4437 | 1.68 | 19.24 | −39.61 | 0.0000 |
| S6 | aspheric | 10.8183 | 0.1011 | | | | 0.0000 |
| S7 | aspheric | 74.7530 | 0.8996 | 1.55 | 56.14 | 27.06 | 0.0000 |
| S8 | aspheric | −18.3325 | 0.7920 | | | | 0.0000 |
| S9 | aspheric | 221.6816 | 0.6586 | 1.57 | 37.40 | 110.72 | 0.0000 |
| S10 | aspheric | −88.1130 | 0.4729 | | | | 0.0000 |
| S11 | aspheric | 3.1573 | 0.6475 | 1.54 | 55.71 | 17.17 | −1.0000 |
| S12 | aspheric | 4.4593 | 1.4412 | | | | −1.0000 |
| S13 | aspheric | 4.8723 | 0.6096 | 1.54 | 55.71 | −9.40 | −1.0000 |
| S14 | aspheric | 2.3694 | 1.1034 | | | | −1.0000 |
| S15 | | infinite | 0.3000 | 1.52 | 64.20 | | 0.0000 |
| S16 | | infinite | 0.4500 | | | | 0.0000 |
| S17 | | infinite | 0.0000 | | | | |

In this embodiment, the object-side surface and the image-side surface of any lens in the first to seventh lenses E1-E7 are both aspheric surfaces, and the surface type x of each aspheric lens may be defined using, but not limited to, the following formula:

$$x = \frac{c {h}^{2}}{1 + \sqrt{1 - ( k + 1 ) {c}^{2} {h}^{2}}} + \sum Ai {h}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 5 above); k is the conic coefficient; and Ai is the correction coefficient of an i-th order of the aspheric surface. Table 6 shows the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S14 in Embodiment 7.

TABLE 6

| surface number | A4 | A6 | A8 | A10 | A12 | A14 | A16 |
|---|---|---|---|---|---|---|---|
| S1 | 7.1621E−03 | −1.2315E−03 | −1.6752E−03 | −6.9552E−04 | 2.6659E−04 | −5.6668E−05 | −2.3328E−05 |
| S2 | −3.8056E−02 | 8.9096E−03 | −3.4355E−03 | 4.2996E−04 | −2.0183E−05 | −1.5269E−05 | −2.0287E−05 |
| S3 | 1.8132E−02 | 2.5200E−02 | −1.6719E−03 | 2.2387E−03 | 1.7988E−04 | 6.9079E−05 | −1.9171E−06 |
| S4 | 2.2394E−02 | 1.3637E−02 | 2.6588E−05 | 1.7075E−03 | 4.0252E−04 | 1.7165E−04 | 6.3007E−05 |
| S5 | −2.9272E−01 | 4.1893E−04 | 2.4280E−03 | 1.9406E−03 | 6.3149E−04 | 1.5694E−04 | 3.4896E−05 |
| S6 | −3.7720E−01 | 2.7858E−02 | 7.8938E−03 | 4.1383E−03 | 2.2644E−03 | 9.3405E−05 | −1.3511E−04 |
| S7 | −1.6386E−01 | −2.2454E−04 | −3.0064E−03 | 2.6433E−03 | 3.5566E−03 | 2.3980E−04 | −1.6950E−04 |
| S8 | −3.8357E−01 | −4.5632E−02 | −8.4495E−03 | 3.3080E−03 | 5.1402E−03 | 2.4707E−03 | 7.3657E−04 |
| S9 | −8.2298E−01 | −1.0185E−01 | 2.7124E−02 | 2.0714E−02 | 5.7241E−03 | −1.9125E−03 | −2.9348E−03 |
| S10 | −1.0223E+00 | 3.1348E−01 | 1.0898E−02 | −2.3976E−02 | −1.7300E−02 | 5.6041E−03 | 4.8242E−03 |
| S11 | −5.2807E+00 | 8.5231E−01 | 1.7541E−01 | −1.0049E−01 | −2.2081E−02 | 7.8417E−03 | 9.5687E−03 |
| S12 | −4.3317E+00 | 3.3736E−01 | 1.5413E−01 | −7.9199E−02 | 5.3859E−02 | 3.3801E−03 | 6.6457E−03 |
| S13 | −7.2674E+00 | 2.7627E+00 | −1.1581E+00 | 4.4611E−01 | −1.4489E−01 | 3.4701E−02 | −1.6667E−02 |
| S14 | −1.3016E+01 | 3.4281E+00 | −1.0501E+00 | 3.9056E−01 | −1.7763E−01 | 6.5380E−02 | −3.6946E−02 |
| S15 | 0.0000E+00 | 0.0000E+00 | 0.0000E+00 | 0.0000E+00 | 0.0000E+00 | 0.0000E+00 | 0.0000E+00 |
| S16 | 0.0000E+00 | 0.0000E+00 | 0.0000E+00 | 0.0000E+00 | 0.0000E+00 | 0.0000E+00 | 0.0000E+00 |
| surface number | A18 | A20 | A22 | A24 | A26 | A28 | A30 |
| S1 | 1.1247E−06 | −3.9649E−06 | 5.3390E−07 | −1.3889E−06 | 4.5278E−07 | −2.3498E−06 | −9.8517E−07 |
| S2 | −1.3245E−05 | −2.1469E−06 | −9.8669E−07 | 7.5881E−07 | 1.7777E−06 | 0.0000E+00 | 0.0000E+00 |
| S3 | −1.1171E−05 | −3.2319E−07 | −2.7462E−06 | −3.6210E−07 | 1.1084E−06 | 1.0028E−06 | 9.2277E−07 |
| S4 | 2.0078E−05 | 1.2118E−05 | 2.9574E−06 | 4.7789E−07 | −1.0552E−06 | −1.5128E−06 | −1.5692E−06 |
| S5 | 1.7836E−06 | 4.7776E−07 | 5.1136E−08 | 6.9340E−07 | 1.0634E−06 | −1.4675E−06 | −6.7804E−07 |
| S6 | −3.5832E−05 | 1.3252E−05 | −1.2130E−05 | 1.4393E−05 | 4.6848E−06 | −3.6701E−06 | −7.3070E−06 |
| S7 | −5.4602E−05 | −5.2446E−05 | −4.3409E−05 | 2.1042E−05 | 1.3167E−05 | −2.4723E−06 | −4.7366E−06 |
| S8 | 1.3645E−05 | −1.6482E−04 | −1.6411E−04 | −9.7532E−05 | −3.8066E−05 | −5.3030E−06 | 3.9261E−06 |
| S9 | −2.0816E−03 | −4.6238E−04 | 2.5167E−04 | 3.6457E−04 | 1.8529E−04 | 3.9797E−05 | −9.9554E−06 |
| S10 | −1.2960E−03 | −8.6837E−04 | −9.7890E−05 | 4.6392E−04 | 8.1717E−05 | −6.6522E−05 | −6.0669E−05 |
| S11 | −3.2917E−03 | −3.4555E−04 | −3.2985E−04 | 2.5538E−04 | 3.4334E−06 | 1.5146E−05 | −1.0900E−05 |
| S12 | −1.1128E−02 | −9.7755E−04 | −5.8906E−04 | 1.4264E−04 | −8.4629E−05 | 6.7290E−05 | 2.3524E−04 |
| S13 | 1.1727E−02 | −6.8716E−03 | 1.7994E−03 | −1.2755E−04 | 7.0004E−05 | −1.8749E−04 | 9.8493E−05 |
| S14 | 2.5756E−02 | −1.6659E−02 | 4.1317E−03 | 3.2329E−04 | 1.1771E−03 | −1.6352E−03 | 6.8698E−04 |
| S15 | 0.0000E+00 | 0.0000E+00 | 0.0000E+00 | 0.0000E+00 | 0.0000E+00 | 0.0000E+00 | 0.0000E+00 |
| S16 | 0.0000E+00 | 0.0000E+00 | 0.0000E+00 | 0.0000E+00 | 0.0000E+00 | 0.0000E+00 | 0.0000E+00 |

For other parameters in Embodiment 7, reference is made to Tables 7 and 8.

### Embodiment 8

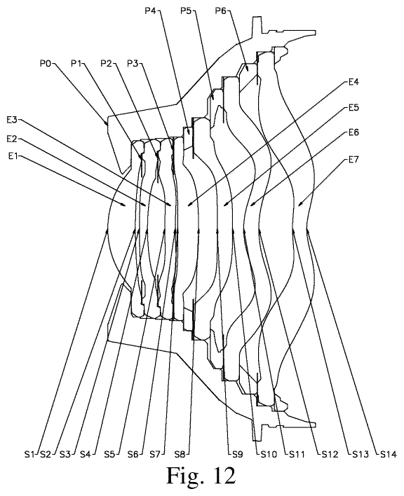

An optical imaging lens assembly according to Embodiment 8 of the present disclosure is described below with reference to FIG. 12.

As shown in FIG. 12, the optical imaging lens assembly includes an optical lens group, a spacing piece group and a lens barrel. The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side.

The table of the basic parameters of the optical imaging lens assembly in this embodiment is the same as Table 5, and the table of the coefficients of the aspheric surfaces is the same as Table 6. This embodiment differs from Embodiment 7 in that the structure sizes of at least some elements in the spacing piece group are different from those in Embodiment 7. For example, the structure size of the inner diameter d5s of the object-side surface of the fifth spacing piece is different from that in Embodiment 7, and the structure size of the inner diameter d6s of the object-side surface of the sixth spacing piece is different from that in Embodiment 7. For details, reference may be made to the data corresponding to Embodiment 8 in Table 8.

### Embodiment 9

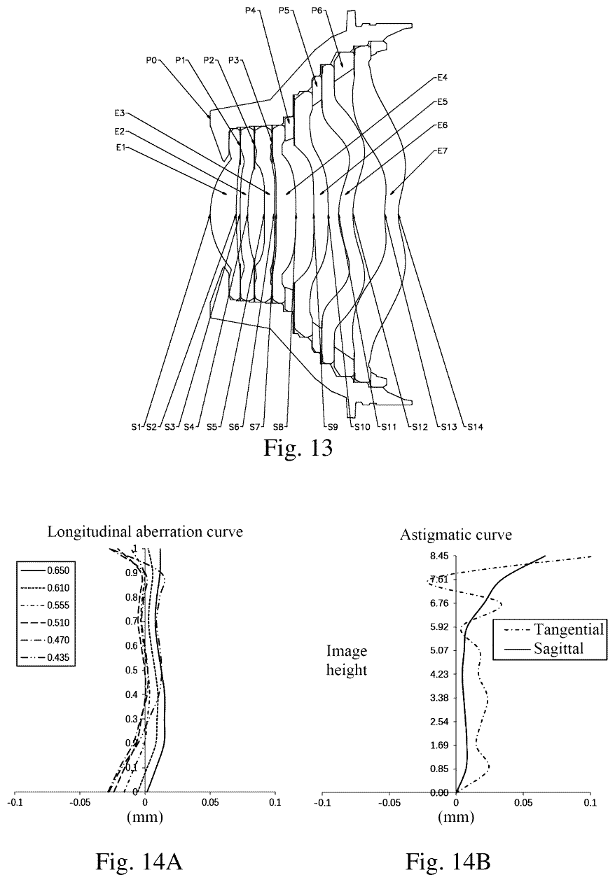

An optical imaging lens assembly according to Embodiment 9 of the present disclosure is described below with reference to FIG. 13.

As shown in FIG. 13, the optical imaging lens assembly includes an optical lens group, a spacing piece group and a lens barrel. The optical lens group includes a first lens E1, a second lens E2, a third lens E3, a fourth lens E4, a fifth lens E5, a sixth lens E6 and a seventh lens E7. The first lens E1, the second lens E2, the third lens E3, the fourth lens E4, the fifth lens E5, the sixth lens E6 and the seventh lens E7 are sequentially arranged along an optical axis to an image side.

The table of the basic parameters of the optical imaging lens assembly in this embodiment is the same as Table 5, and the table of the coefficients of the aspheric surfaces is the same as Table 6. This embodiment differs from Embodiment 7 in that: the structure sizes of at least some elements in the spacing piece group are different from those in Embodiment 7. For example, the structure size of the inner diameter d5s of the object-side surface of the fifth spacing piece is different from that in Embodiment 7, and the structure size of the inner diameter d6s of the object-side surface of the sixth spacing piece is different from that in Embodiment 7. For details, reference may be made to the data corresponding to Embodiment 9 in Table 8.

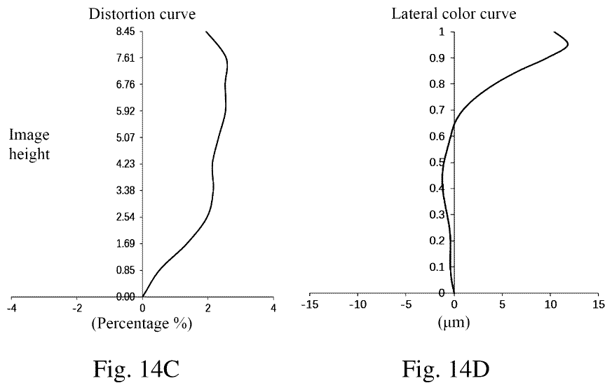

Referring to FIGS. 14A-14D, FIG. 14A illustrates a longitudinal aberration curve of the optical imaging lens assembly of Embodiment 7, 8 or 9, representing deviations of focal points of light of different wavelengths converged after passing through the optical imaging lens assembly. FIG. 14B illustrates an astigmatic curve of the optical imaging lens assembly of Embodiment 7, 8 or 9, representing a curvature of a tangential image plane and a curvature of a sagittal image plane that correspond to a different image height. FIG. 14C illustrates a distortion curve of the optical imaging lens assembly of Embodiment 7, 8 or 9, representing amounts of distortion corresponding to different image heights. FIG. 14D illustrates a lateral color curve of the optical imaging lens assembly of Embodiment 7, 8 or 9, representing deviations of different image heights on the image plane after light passes through the lens assembly. It can be seen from FIGS. 14A-14D that the optical imaging lens assembly given in Embodiments 7, 8 or 9 can achieve a good imaging quality.

Table 7 shows the values of the optical parameters such as |SAG11|, |SAG51|, |SAG62|, |SAG71|, DT42 and DT32 in each of Embodiments 1-9.

TABLE 7

| | Embodiment | | | | | | | | |
|---|---|---|---|---|---|---|---|---|---|
| Parameter | 1 | 2 | 3 | 4 | 5 | 6 | 7 | 8 | 9 |

| | | | |
|---|---|---|---|
| f (mm) | 8.57 | 8.55 | 8.56 |
| f56 (mm) | 11.58 | 14.92 | 14.74 |
| FOV(°) | 87.76 | 88.32 | 88.00 |
| \|SAG11\| (mm) | 0.89 | 0.86 | 0.86 |
| \|SAG51\| (mm) | 0.80 | 0.89 | 0.85 |
| \|SAG62\| (mm) | 0.95 | 0.81 | 0.81 |
| \|SAG71\| (mm) | 1.47 | 1.38 | 1.36 |
| DT42 (mm) | 2.72 | 2.68 | 2.67 |
| DT32 (mm) | 2.37 | 2.29 | 2.28 |

Table 8 shows the values of the parameters such as d1s, d4s, D4s, D4m, d5s, d5m, D5s, d6s, d6m, d0s, d0m, EP01, EP23, EP45, CP5 and CP6 in each of Embodiments 1-9. Here, the above parameters can be measured according to the marking method shown in FIG. 1, and the units of the parameters listed in Table 8 are all mm.

TABLE 8

| Condi- | | | | | | | | | |
|---|---|---|---|---|---|---|---|---|---|
| tional | | | | | | | | | |
| expres- | Embodiment | | | | | | | | |
| sion | 1 | 2 | 3 | 4 | 5 | 6 | 7 | 8 | 9 |
| d1s | 4.67 | 4.77 | 4.56 | 4.41 | 4.38 | 4.45 | 4.29 | 4.43 | 4.51 |
| d4s | 6.53 | 6.14 | 6.75 | 6.68 | 6.95 | 6.53 | 6.72 | 6.64 | 6.53 |
| D4s | 8.88 | 9.02 | 9.48 | 8.73 | 9.26 | 6.78 | 8.57 | 8.40 | 8.52 |
| D4m | 8.86 | 9.06 | 9.46 | 8.72 | 9.28 | 7.05 | 8.55 | 8.39 | 8.50 |
| d5s | 8.31 | 8.51 | 8.88 | 8.24 | 8.90 | 8.68 | 8.41 | 8.50 | 9.66 |
| d5m | 10.10 | 10.24 | 10.23 | 9.98 | 10.24 | 9.74 | 10.14 | 10.18 | 10.24 |
| D5s | 10.66 | 10.86 | 11.39 | 10.50 | 11.00 | 11.75 | 10.67 | 11.08 | 11.90 |
| d6s | 11.33 | 11.52 | 11.87 | 11.75 | 11.70 | 11.50 | 11.59 | 11.51 | 11.88 |
| d6m | 12.79 | 12.90 | 13.20 | 12.74 | 13.16 | 13.21 | 12.87 | 13.02 | 13.04 |
| d0s | 4.69 | 4.59 | 4.66 | 4.88 | 4.75 | 4.73 | 4.85 | 4.61 | 4.69 |
| d0m | 16.30 | 16.36 | 16.60 | 16.49 | 16.64 | 16.90 | 16.35 | 16.36 | 16.66 |
| EP01 | 1.48 | 1.42 | 1.55 | 1.28 | 1.53 | 1.24 | 1.45 | 1.44 | 1.35 |
| EP23 | 0.70 | 0.77 | 0.66 | 0.72 | 0.58 | 0.72 | 0.64 | 0.66 | 0.80 |
| EP45 | 0.52 | 0.95 | 0.66 | 0.62 | 0.65 | 0.73 | 0.57 | 0.74 | 0.84 |
| CP4 | 0.38 | 0.33 | 0.47 | 0.43 | 0.50 | 0.40 | 0.43 | 0.40 | 0.39 |
| CP5 | 0.64 | 0.58 | 0.53 | 0.64 | 0.59 | 0.42 | 0.73 | 0.55 | 0.41 |
| CP6 | 0.75 | 0.78 | 0.72 | 0.75 | 0.87 | 0.84 | 0.82 | 0.77 | 0.89 |

Table 9 shows the values of the condition expressions in each of Embodiments 1-9.

TABLE 9

| Conditional | Embodiment | | | | | | | | |
|---|---|---|---|---|---|---|---|---|---|
| expression | 1 | 2 | 3 | 4 | 5 | 6 | 7 | 8 | 9 |
| (d6s − d5s)/T56 | 5.62 | 5.60 | 5.57 | 7.88 | 6.29 | 6.33 | 6.72 | 6.36 | 4.69 |
| d4s/DT42 | 2.40 | 2.26 | 2.48 | 2.49 | 2.59 | 2.44 | 2.52 | 2.49 | 2.45 |
| EP45/(D5s − D4m) | 0.29 | 0.53 | 0.34 | 0.35 | 0.38 | 0.16 | 0.27 | 0.28 | 0.25 |
| EP23/CT3 | 1.41 | 1.55 | 1.33 | 1.60 | 1.29 | 1.60 | 1.44 | 1.49 | 1.80 |
| (R1 + R2)/d1s | 3.56 | 3.48 | 3.64 | 4.05 | 4.08 | 4.02 | 4.28 | 4.14 | 4.07 |
| EP01/\|SAG11\| | 1.66 | 1.60 | 1.74 | 1.49 | 1.78 | 1.44 | 1.69 | 1.67 | 1.57 |
| (d5m − d5s)/R11 | 0.49 | 0.47 | 0.37 | 0.56 | 0.43 | 0.34 | 0.55 | 0.53 | 0.18 |
| d5s/R11 | 2.27 | 2.33 | 2.43 | 2.65 | 2.86 | 2.79 | 2.66 | 2.69 | 3.06 |
| EP45/\|SAG51\| | 0.65 | 1.19 | 0.83 | 0.70 | 0.73 | 0.82 | 0.67 | 0.87 | 0.99 |
| CP6/T67 | 0.53 | 0.55 | 0.51 | 0.51 | 0.60 | 0.57 | 0.57 | 0.53 | 0.62 |
| f56/R12*(CP5/CT5) | 1.67 | 1.52 | 1.38 | 3.30 | 3.04 | 2.17 | 3.66 | 2.76 | 2.06 |
| (d0m − d0s)/f7 | −1.40 | −1.41 | −1.44 | −1.26 | −1.29 | −1.32 | −1.22 | −1.25 | −1.27 |
| (D4s − DT32)/CP4 | 17.13 | 20.15 | 15.13 | 14.98 | 13.94 | 11.23 | 14.63 | 15.30 | 16 |
| d6m/R12*(f6/CP6) | 32.84 | 31.85 | 35.32 | 58.28 | 51.90 | 53.96 | 60.43 | 65.11 | 56.41 |
| (T67 − CP6)/(\|SAG71\| − | 1.27 | 1.22 | 1.05 | 1.25 | 1.04 | 1.09 | 1.13 | 1.22 | 1.00 |
| \|SAG62\|) | | | | | | | | | |

An embodiment of the present disclosure further provides an imaging apparatus having an electronic photosensitive element which may be a charge coupled device (CCD) or complementary metal-oxide semiconductor element (CMOS). The imaging apparatus may be an independent imaging device such as a digital camera, or may be an imaging module integrated in a mobile electronic device such as a mobile phone. The imaging apparatus is equipped with the optical imaging lens assembly described above.

The foregoing is only a description for the preferred embodiments of the present disclosure and the applied technical principles. It should be appreciated by those skilled in the art that the inventive scope of the present disclosure is not limited to the technical solution formed by the particular combination of the above technical features. The inventive scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical imaging lens assembly, comprising:
an optical lens group, comprising a first lens, a second lens, a third lens, a fourth lens, a fifth lens, a sixth lens and a seventh lens that are sequentially arranged along an optical axis from an object side to an image side, wherein the first lens has a positive refractive power, the second lens has a negative refractive power, the third lens has a negative refractive power, the fourth lens has a positive refractive power, the fifth lens has a positive refractive power, the sixth lens has a positive refractive power, and the seventh lens has a negative refractive power;
a spacing piece group, comprising a fifth spacing piece and a sixth spacing piece, wherein the fifth spacing piece is placed between the fifth lens and the sixth lens and in at least partial contact with the fifth lens, and the sixth spacing piece is placed between the sixth lens and the seventh lens and in at least partial contact with the sixth lens;
a lens barrel, accommodating the optical lens group and the spacing piece group,
wherein a maximal thickness CP6 of the sixth spacing piece along a direction of the optical axis is greater than a center thickness CT6 of the sixth lens on the optical axis, and
an inner diameter d5s of an object-side surface of the fifth spacing piece, an inner diameter d6s of an object-side surface of the sixth spacing piece, and a spacing distance T56 between the fifth lens and the sixth lens on the optical axis satisfy:
$$4.5 < ( d 6 s - d 5 s ) / T 56 < 8.0 .$$

2. The optical imaging lens assembly according to claim 1, wherein the spacing piece group further comprises a fourth spacing piece, and the fourth spacing piece is placed between the fourth lens and the fifth lens and in at least partial contact with the fourth lens,
wherein an inner diameter d4s of an object-side surface of the fourth spacing piece and a maximal effective radius DT42 of an image-side surface of the fourth lens satisfy: 2.0<d4s/DT42<2.8.

3. The optical imaging lens assembly according to claim 1, wherein the spacing piece group further comprises a fourth spacing piece, and the fourth spacing piece is placed between the fourth lens and the fifth lens and in at least partial contact with the fourth lens,
wherein a spacing distance EP45 between an image-side surface of the fourth spacing piece and the object-side surface of the fifth spacing piece along the direction of the optical axis, an outer diameter D5s of the object-side surface of the fifth spacing piece, and an outer diameter D4m of the image-side surface of the fourth spacing piece satisfy: 0.1<EP45/(D5s−D4m)<0.6.

4. The optical imaging lens assembly according to claim 1, wherein the spacing piece group further comprises a second spacing piece and a third spacing piece, the second spacing piece is placed between the second lens and the third lens and in at least partial contact with the second lens, and the third spacing piece is placed between the third lens and the fourth lens and in at least partial contact with the third lens,
wherein a spacing distance EP23 between an image-side surface of the second spacing piece and an object-side surface of the third spacing piece along the direction of the optical axis and a center thickness CT3 of the third lens on the optical axis satisfy: 1.0<EP23/CT3<2.0.

5. The optical imaging lens assembly according to claim 1, wherein the spacing piece group further comprises a first spacing piece, and the first spacing piece is placed between the first lens and the second lens and in at least partial contact with the first lens,
wherein a radius of curvature R1 of an object-side surface of the first lens, a radius of curvature R2 of an image-side surface of the first lens, and an inner diameter d1s of an object-side surface of the first spacing piece satisfy: 3.0<(R1+R2)/d1s<4.5.

6. The optical imaging lens assembly according to claim 1, wherein the spacing piece group further comprises a first spacing piece, and the first spacing piece is placed between the first lens and the second lens and in at least partial contact with the first lens,
wherein a spacing distance EP01 from an object-side end surface of the lens barrel to an object-side surface of the first spacing piece along the optical axis and an axial distance SAG11 from an intersection point of an object-side surface of the first lens and the optical axis to a projection point of an effective radius vertex of the object-side surface of the first lens onto the optical axis satisfy:
$$1.2 < EP 01 / \vert SAG 11 \vert < 2. .$$

7. The optical imaging lens assembly according to claim 1, wherein the spacing piece group further comprises a fourth spacing piece, and the fourth spacing piece is placed between the fourth lens and the fifth lens and in at least partial contact with the fourth lens,
wherein a spacing distance EP45 between an image-side surface of the fourth spacing piece and the object-side surface of the fifth spacing piece along the direction of the optical axis, and an axial distance SAG51 from an intersection point of an object-side surface of the fifth lens and the optical axis to a projection point of an effective radius vertex of the object-side surface of the fifth lens onto the optical axis, satisfy: 0.5<EP45/|SAG51|<1.3.

8. The optical imaging lens assembly according to claim 1, wherein the spacing piece group further comprises a fourth spacing piece, and the fourth spacing piece is placed between the fourth lens and the fifth lens and in at least partial contact with the fourth lens,
wherein an outer diameter D4s of an object-side surface of the fourth spacing piece, a maximal effective radius DT32 of an image-side surface of the third lens, and a maximal thickness CP4 of the fourth spacing piece along the direction of the optical axis satisfy: 11<(D4s−DT32)/CP4<20.5.

9. The optical imaging lens assembly according to claim 1, wherein an inner diameter d6m of an image-side surface of the sixth spacing piece, a radius of curvature R12 of an image-side surface of the sixth lens, an effective focal length f6 of the sixth lens, and the maximal thickness CP6 of the sixth spacing piece along the direction of the optical axis satisfy: 31<d6m/R12*(f6/CP6)<66.

10. The optical imaging lens assembly according to claim 1, wherein the maximal thickness CP6 of the sixth spacing piece along the direction of the optical axis, a spacing distance T67 between the sixth lens and the seventh lens on the optical axis, an axial distance SAG71 from an intersection point of an object-side surface of the seventh lens and the optical axis to an effective radius vertex of the object-side surface of the seventh lens, and an axial distance SAG62 from an intersection point of an image-side surface of the sixth lens and the optical axis to a projection point of an effective radius vertex of the image-side surface of the sixth lens onto the optical axis satisfy: 1.0≤(T67−CP6)/(|SAG71|−|SAG62|)<1.6.

11. The optical imaging lens assembly according to claim 1, wherein an inner diameter d5m of an image-side surface of the fifth spacing piece, the inner diameter d5s of the object-side surface of the fifth spacing piece, and a radius of curvature R11 of an object-side surface of the sixth lens satisfy: 0.15<(d5m−d5s)/R11<0.6.

12. The optical imaging lens assembly according to claim 1, wherein the inner diameter d5s of the object-side surface of the fifth spacing piece and a radius of curvature R11 of an object-side surface of the sixth lens satisfy: 2.0<d5s/R11<3.2.

13. The optical imaging lens assembly according to claim 1, wherein the maximal thickness CP6 of the sixth spacing piece along the direction of the optical axis, and a spacing distance T67 between the sixth lens and the seventh lens on the optical axis satisfy: 0.4<CP6/T67<0.7.

14. The optical imaging lens assembly according to claim 1, wherein a combined focal length f56 of the fifth lens and the sixth lens, a radius of curvature R12 of an image-side surface of the sixth lens, a center thickness CT5 of the fifth lens on the optical axis, and a maximal thickness CP5 of the fifth spacing piece along the direction of the optical axis satisfy: 1.3<f56/R12*(CP5/CT5)<3.8.

15. The optical imaging lens assembly according to claim 1, wherein an inner diameter d0s of an object-side surface of the lens barrel, an inner diameter d0m of an image-side surface of the lens barrel, and an effective focal length f7 of the seventh lens satisfy: −1.5<(d0m−d0s)/f7<−1.2.
